(19) United States
(12) Patent Application Publication
(10) Pub. No.: US 2012/0109721 A1
(43) Pub. Date: May 3, 2012

(54) IMPROVEMENTS RELATING TO EFFICIENT TRANSPORT

(76) Inventors: Peter Cebon, Armadale (AU); Daniel Samson, Balwyn (AU); Andrew Thomas, Glen Iris (AU); Christopher Thomas, Glen Iris (AU)

(21) Appl. No.: 13/259,085

(22) PCT Filed: Mar. 24, 2010
(86) PCT No.: PCT/AU2010/000343

§ 371 Date: Dec. 28, 2011

(30) Foreign Application Priority Data
Mar. 25, 2009 (AU) 2009901293
Jun. 14, 2009 (AU) 2009902714

(51) Int. Cl. G07B 15/00; G08G 1/123

(52) U.S. Cl. 705/13; 340/994

(57) ABSTRACT

A system for handling transport information comprising hardware to receive information, hardware to transmit information and optionally hardware to store information.

### BACKGROUND OF THE INVENTION

There is increasing demand for novel applications using transport-related data. Many social and business systems involving transactions are inefficient because information about particular transactions is not readily visible to the parties who are not participating directly in that transaction. If that data could be made available, those third parties could make better decisions about actions that are contingent on that transaction. For example, potential passengers may need to use several modes of transport and need updates regarding whether they will arrive on time to make their connections. Similarly, some transport planners and controllers want to know where all the vehicles are, and whether or not they are running to schedule. Some of the difficulties which have in the past thwarted the development of more efficient systems include:
It is difficult and expensive to add qualitatively different sensors (e.g. different designs or fitted to different classes of vehicles) to an existing data system;
It is difficult and expensive to draw data from sensors that were not previously integrated, in order to create new applications;
It is difficult and expensive to develop applications that draw real-time data from sensors, when several applications require the same real-time data;
It is difficult to capture data involving more than the location of sensors
The systems for capturing those location data tend to have limited reliability
It is difficult to process transactions at the location of the sensor.

The reference to any prior art in this specification is not, and should not be taken as, an acknowledgement or any form of suggestion that the prior art forms part of the common general knowledge.

### SUMMARY OF THE INVENTION

According to a first aspect of the invention, there is provided a system for handling transport information comprising hardware to receive information, hardware to transmit information and optionally hardware to store information. In some embodiments there is provided a system comprising hardware to share information based on one or more criteria, the criteria optionally comprising registration to use the system. In some embodiments there is provided a system wherein the information comprises real-time information which is optionally aggregated and optionally from one or more sensors. In some embodiments there is provided a system comprising hardware to enable one or more users to interact with the information and optionally in real time. In some embodiments there is provided a system adapted for use with a transportation domain and optionally in relation to one or more of: public transport, emergency services, commercial transport, freight, passenger transport and the like.

According to a second aspect of the invention, there is provided a system for handling public transport information in a transportation domain comprising hardware to receive, transmit, store and aggregate real-time information, hardware to enable one or more users to interact with the information in real time and hardware to share information based on one or more criteria, the criteria comprising registration to use the system, wherein the information is aggregated from one or more sensors.

According to a third aspect of the invention there is provided a method for handling transport information comprising the steps of receiving information, transmitting information and optionally storing information. In some embodiments there is provided a method composing the step of sharing information based on one or more criteria, the criteria optionally comprising registration to use the system. In some embodiments there is provided a method wherein the information comprises real-time information which is optionally aggregated and optionally from one or more sensors. In some embodiments there is provided a method wherein one or more users may interact with the information and optionally in real time. In some embodiments there is provided a method for use with a transportation domain and optionally in relation to one or more of: public transport, emergency services, commercial transport, freight, passenger transport and the like.

In some embodiments there is provided a method as herein described in one or more of the Scenarios, Modules or by reference to one or more of FIGS. 2 to 14 herein. In some embodiments there is provided a method as herein described for optionally one or more of:
a. Choosing between transportation modes
b. Opening and closing a transaction
c. Observing the state of a variable at a remote location
d. Service provider registering an intended route or schedule or preference
e. Services consumer registering an intended route or schedule or preference
f. Matching transaction partners
g. Bringing transaction partners together physically
h. Ensuring the safety of transaction partners
i. Reliably aggregating data in complex evolving systems so that system optimizations might be carried out frequently.

In same embodiments there is provided a method for enabling car pooling comprising one or more of the following
a. pooling users are registered in a database;
b. pooling users are checked against a registry of compliance information prior to entering into a transaction;
c. pooling users have the capacity to authenticate the other party as the person who is registered in the database;
d. allowing some pool users to have the capacity to restrict, select, or veto the riding partners of other riders (e g parents).
e. allowing some pool users have the capacity to monitor the rides of other users in real time (e.g. parents);
f. journeys are monitored by an external authority
g. procedures are in place for managing a safety threat

In some embodiments there is provided a method one or more of:
a. providing users the capacity to examine the value of a state variable, or the forecast of that state variable, related to a remote location's ability to satisfy their needs.
b. planning journeys based on the value of a state variable.
c. providing people the capacity to plan journeys using real-time data
d. providing agents with the capacity to manage centrally-coordinated complex logistics systems using real-time data, where those logistics systems are centrally coordinated (e.g. freight or military logistics), or where they involve local improvisation (e.g. disaster response).
e. registering providers and recipients of transportation services such that every time the person initiates a transaction, the system re-validates their eligibility and updates their status within the system. (eg. checks they still have a valid licence and no demerit points.)
f. enabling participants in a transaction to authenticate the other party through the use of photos of the person, photos of the vehicle, signatures, vehicle registration numbers, finger prints, iris scans, voice spectra, voice recordings etc.
g. calculating expected trip durations using a method that incorporates real-time traffic conditions, and/or a model of expected traffic conditions based on historical data, and/or historical behaviour of that driver.
h. taxis having the capability to only take a ride in a pre-specified area or direction.
i. booking trucks for their return journeys.
j. assuring safety for passengers undertaking trips. (i.e. authentication+filters+monitoring+panic+intervention)
k. monitoring car-pools and other transportation services—i.e. the system triggers on deviation from a nominated route.
l. monitoring car-pools and other transportation services—i.e. the system triggers on the basis of sensors being proximate then separated
m. assuring someone's safety whereby they input a PIN into someone else's personal sensor.
n. assuring someone's safety whereby a private vehicle is fitted with a camera/audio device and that camera/audio device transmits images and/or sound to an external party in response to a command by that external party
o. recording the location of a stationary vehicle by various methods, including a sensor attached to it, the location at which a previous transaction was closed, or by someone pushing a button on a sensor.
p. using data about the location of a stationary vehicle to guide a party to that vehicle.
q. enabling VOIP or Chat communication between two parties when they come within a specified time or distance from each other
r. automatically opening a transaction when two sensors are registered as being co-located, or a sensor reaches a specified location.
s. automatically closing a transaction when two paired sensors separate.
t. automatically closing a transaction for transportation services when a pre-specified location is reached.
u. facilitating frequent updating of data inputs for optimization routines for managing complex dynamic scheduling problems

In a fourth aspect of the invention there is provided a storage device comprising machine readable instructions to carry out any one or more of the methods or steps described herein.

This invention improves the ease and efficiency with which people travel and consume services. It achieves that by managing information and enabling transactions. Every action to travel, whether it be to walk, cycle, drive, car-pool, or catch a taxi, bus or tram, train or plane is preceded by a decision. People make that decision on the basis of the information available at the time. This invention improves the quality, availability and timeliness of that information, with a view to improving decision-making. In addition, it enables people to engage in financial and other transactions in real-time at distributed locations The focus is on travel and associated information within a transportation domain. A transportation domain is a region in which transportation-related services and activities are reasonably interdependent. It is usually a city, but could also include the hinterland for that city, or might comprise a complex of multiple cities (such as in the North East U.S.A.), or a network of cities (as with air transport and shipping transport systems). Alternatively, it could be as small as a factory floor.

In many situations, associated with transportation are six types of information:—(1) information about the vehicles (which includes pedestrians) (such as their location or conformance to a schedule), (2) information about the context in which the vehicles are travelling (such as the state of traffic lights or the level of congestion on the road), (3) information about the content of the vehicles (such as the level of crowding on a bus or the contents of a freight shipment), (4) information about the characteristics of the services that are the reason for some forms of travel in the first place (such as the number of available treadmills at a gym), (5) information about the people who are travelling, and (6) information related the value that is created or lost by exploiting the first five types of information.

This information can be valuable to people who are not proximate to its source. It may be also used as the basis for transactions Therefore, various tools and techniques have been developed to capture that information, process it, and make it available it to the recipient. One example of such a tool is a bill of lading which is an inventory of the contents of a freight shipment. Traditionally, it is written on paper and accompanies the shipment. Another example is a set of sensors under the road, which provide information about traffic flows through an intersection. That information is transmitted to a computer system that, possibly with the assistance of predictive models, is used to control the timing of traffic lights. A third example is a set of software programs and communications links that enable people to download schedule information (either time-tabled, or real-time) about public transportation vehicles to their mobile phone. A fourth example is an automated ticketing system which captures a record of people boarding and alighting public transport vehicles, transmits that information to a central data store, and deducts the value of their fare from their account.

These various tools and techniques all involve capturing data using sensors and then processing them using an application. Sensors and applications are defined below. It is useful to consider the current state of the art as existing in two domains. In the first domain, applications and associated data gathering are designed in response to specific information and transaction needs. Sometimes, this is just for one closely related set of data—such as location and transaction data for taxis. Other times, the net is slightly broader, as with Electronic Data Interchange systems for freight. Notwithstanding, as a general statement, sensors and applications are tightly coupled That is, sensors are installed and data are gathered with the data needs of a particular application or set of applications in mind, and applications are designed for particular sets of sensors, and data, in an application-specific format.

To substitute different sensors, or to construct novel applications drawing data from multiple existing sensors, requires considerable engineering effort. Furthermore, in the present state of the art, data are generally only available on a “pull” basis for those for whom the system was not explicitly designed. For example, in most cities, if an individual wishes to locate a taxi, they must interrogate a database of recent taxi locations. The taxi system can not currently automatically inform them (e g to a map) of the locations of taxis Furthermore, in this first domain, integration of those data so as to provide multimodal information is a prodigious engineering challenge. This first domain is depicted schematically in FIG. 1. Some sets of similar sensors, S1-S6, are connected directly, or indirectly, to a set of servers SV1-SV6, which, in turn, provide data to drive applications A1-A5. For example, sensor set S1 might be a set of computers in taxis that transmit their availability and location, while sensor set S2 might be the set of GPS's in suburban trains. Server SV3 might contain timetable data for the train network A1 might be driving a set of electronic signs at stations and bus stops. In the second domain, techniques have recently been developed to capture location data from people and vehicles and deliver it to subscribers in real-time.

The present state of the art is problematic. There is increasing demand for novel applications using transport-related data. Many social and business systems involving transactions are inefficient because information about particular transactions is not readily visible to the parties who are not participating directly in that transaction If those data could be made available, thse third parties could take actions that are contingent on that transaction. For example, potential passengers may need to use several modes of transport and need updates regarding whether they will arrive on time to make their connections. Similarly, some transport planners and controllers want to know where all the vehicles are, and whether or not they are running to schedule. Someone riding in a car-pool or a taxi may wish to have the assurance that their journey is being monitored by a third party. A potential shopper may wish to know if a particular shop is crowded before travelling to it or which parking garages have available spots. A transport auditor may wish to analyze the performance and crowding data from a number of vehicles across a number of transport modes at a number of locations through time. These novel applications often require data to be drawn from diverse sources and integrated in novel ways, often in real-time. They also often need data about other state variables associated with a vehicle beyond its location (such as its level of crowding), and the capacity to carry out financial and physical transactions involving those state variables. At the same time, many computerized sensors are significantly reducing in cost. Because of the advent of the mobile telephone, many people carry sensors, data transmission networks are readily available, and independent sensors can be built and deployed cheaply. This means that it is potentially possible to dramatically increase the amount of data available to applications.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1: Schematic Drawing of the first domain of the present state of the art

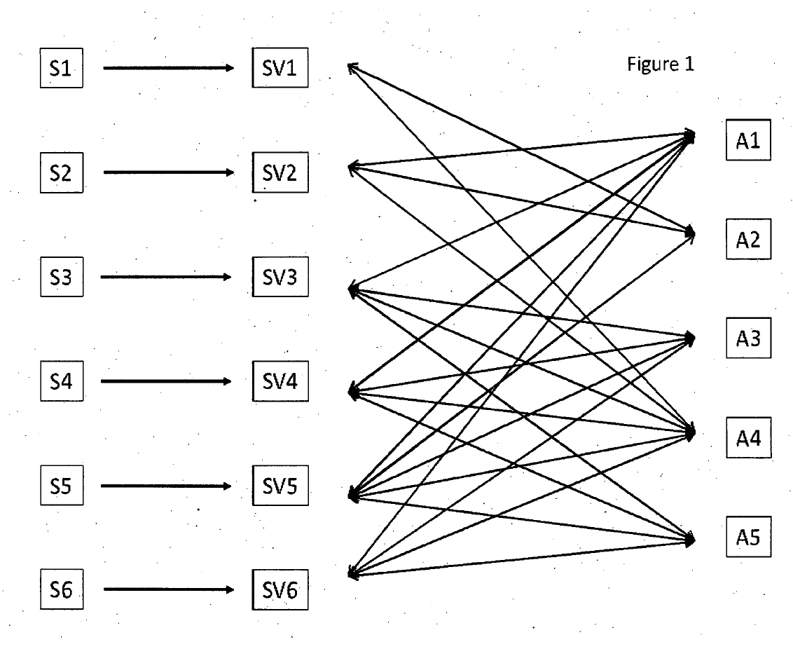

FIG. 2: Schematic Drawing showing sensor inputs and application outputs for an informatics Bus and Store (combined as a Hub) according to one embodiment

FIG. 3: Schematic Drawing showing functions of the Bus and Information Stare

FIG. 4: Schematic Drawing showing functions of the Hub when registering users

FIG. 5: Schematic Drawing showing functions of the Hub when users of applications choose between transport modes

FIG. 6: Schematic Drawing showing functions of the Hub when users or applications open or close a transaction

FIG. 7: Schematic Drawing showing functions of the Hub when executing a financial transaction

FIG. 8: Schematic Drawing showing functions of the Hub when a user or application observes the state of a variable at a remote location

FIG. 9: Schematic Drawing showing functions of the Hub when a service provider registers an intended route and/or schedule

FIG. 10: Schematic Drawing showing functions of the Hub when a service consumer registers a desired route and/or time

FIG. 11: Schematic Drawing showing functions of the Hub when an application matches transaction partners

FIG. 12: Schematic Drawing showing functions of the Hub when an application brings partners together physically

FIG. 13: Schematic Drawing showing functions of the Hub when an application and/or users attempt to ensure the safety of transaction partners

FIG. 14: Schematic Drawing showing functions of the Hub gathering data during an evolving emergency, performing repeated system optimizations, and relaying data about the current situation to all users and the results of the optimizations to some users.

### DETAILED DESCRIPTION OF EXEMPLARY EMBODIMENTS

It is convenient to describe the invention herein in relation to particularly preferred embodiments. However, the invention is applicable to a wide range of situations and it is to be appreciated that other constructions and arrangements are also considered as falling within the scope of the invention. Various modifications, alterations, variations and or additions to the construction and arrangements described herein are also considered as falling within the ambit and scope of the present invention.

As used herein, the term ‘sensor’ means a physical object providing data from the environment, or a computer model providing predictions or records of the value of data in the environment. Examples of sensors include, but are not limited to:
a logical device on a mobile telephone;
a GPS device;
a video camera in a café providing a visual indication of the level of congestion and other visual information,
a device in a bank providing a numerical indication of the level of congestion.
a device indicating the state of a traffic light;
a traffic counter butted in the roadway of mounted overhead;
a computer forwarding data captured from an external device and transmitted to it by point-to-point transmission or a 3G transmission;
a computer model predicting the current state of a variable on the basis of historical data and theoretical models;
a computer model predicting the future availability of spaces in a parking lot on the basis of current data, historical data and a model;
a keyboard from which data are entered manually
an enterprise software system forwarding data from a database, where the data describe the characteristics of an object.

As used herein, the term ‘Hub’ means an infrastructure asset. In some embodiments, the Hub comprises standards and associated software, hardware, and capabilities. A Hub performs three functions:
It receives data from sensors
It stores those data. Data may be stored in a number of ways. In some embodiments, the data are stored in such a way that information about the originating sensor forms part of the data In some examples the data is stored in a manner such that the data are effectively decoupled from the originating sensor. That is, once the data are in the Hub, they can be accessed without reference to their origination.
It makes those data available to applications, in real-time if desired. (Where real-time is understood to include the possibility of short lags for data transmission and processing).

Key to abbreviations in the figures
User #1
PMD Device containing the personal mobile sensor and applications of user #1
ES External sensor of user #1 (e.g. program on P.C.)
VMD Device, mounted on the vehicle of user #1 containing the vehicle-mounted sensor of user #1 and applications
User #2
PMD Device containing the personal mobile sensor of user #2 and applications
ED External device of user #2 containing a sensor and applications
EDB Pre-existing database of external registrar
NDB Newly created database of external registrar of Hub operation
VDB External database containing verification data about the registrant (e.g. criminal record database, creditworthiness database).
FS Fixed sensor (e.g. counts bicycles on a rack)
V Vehicle of user #1
EP External party (e.g. the police)
RU Another registered user (e.g. the parent of a car-pooling child)

The applications are effectively de-coupled from the sensors That is, many applications can potentially receive the same data simultaneously.

As used herein, the term ‘application’ means a method, usually embodied within and/or operated by a computer program, which moves data between users, sensors, and the Hub and/or executes calculations and transactions in order to provide a service to end-users.

Two particular types of sensor are referred to below. The first is a vehicle-mounted mobile sensor, while the second is a personal mobile sensor.

In some embodiments there is provided a vehicle-mounted sensor. According to these embodiments, a vehicle-mounted mobile sensor may for example have one or more of the following characteristics:
A GPS or other method to determine the location of the vehicle.
The capacity to time-stamp transmissions to a common clock.
A radio to transmit location data and other information about the vehicle.
Memory containing information about the vehicle (e.g. the vehicle identity, location, number of occupants and other information)
Software enabling it to transmit information from memory.
Software enabling it to receive and process information.
The ability to receive information from the vehicle (e.g. estimates of the level of crowding of buses; sensor information about engine performance, identification information about the driver or passengers),
The ability to communicate with other proximate devices (e.g. by Bluetooth),
The ability to output information to the driver and passengers (e.g. a screen or USB, Bluetooth output to a screen, direct to a printer, or with an electronic voice),
The ability to draw power from the vehicle's power system.

In some embodiments there is provided a personal mobile sensor. An example implementation of a personal mobile sensor is as a logical device on a smart-phone. The sensor may for example have the following characteristics:
A GPS or other device to determine the location of the sensor.
The capacity to time-stamp transmissions to a common clock
A radio to transmit location data and other information and to receive information from the Hub.
Memory containing information about the user (e.g. an identification number)
Software enabling it to transmit information from memory.
Software enabling it to receive and process information.
The ability to be reprogrammed or reset.

In some embodiments there is provided a vehicle-mounted device. A vehicle-mounted device is a physical device, or set of physical devices, that may contain a number of logical devices and a number of applications. At least one of those logical devices will be a vehicle-mounted sensor

In some embodiments there is provided a personal mobile device. An example of a personal mobile device is a smart phone. The personal mobile device is a physical device, or set of physical devices, that may contain a number of logical devices and a number of applications At least one of those logical devices will be a personal mobile sensor.

In some embodiments there is provided an external device. An example of an external device is a personal computer The external device is a physical device, or set of physical devices, that may contain a number of logical devices and a number of applications. At least one of those logical devices will be a sensor.

The described invention provides a method for overcoming the above limitations of the present state of the art. It comprises a Hub and an associated set of applications. That is, it creates a method for adding sensors to an existing network of sensors at low cost, and it creates a method for constructing a diverse range of applications that exploit data from a wide range of sensors

The Hub

As defined above, the Hub performs three functions, it receives data from sensors, it stores those data in a manner such that the data are effectively decoupled from the originating sensor, and it makes those data available to applications, in real-time if desired.

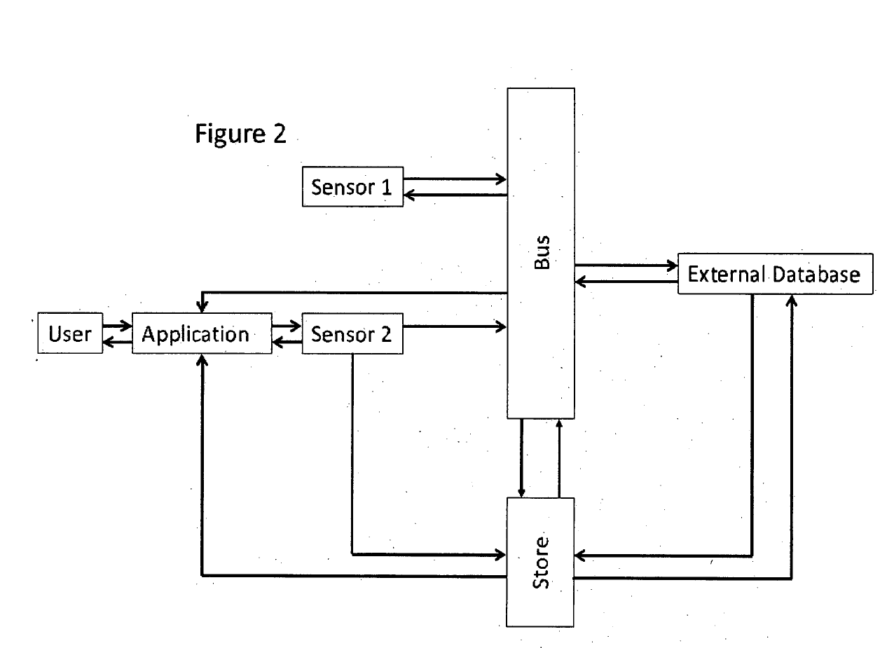

In one embodiment, the Hub is hosted on a computer, or set of computers, and comprises two major parts—a Bus and an Information Store. The Bus is able to receive real-time information about the state of sensors and real-time information relevant to transactions from applications, and to publish that information in real-time to applications that have registered subscriptions for specific information. In order to achieve this, a Bus performs five basic functions, which are described below. The Information Store aggregates state information on sensors and historical information on transactions. It may also receive information from users (for example, via a sensor, or via a communications module, or any suitable means) and publish data directly to applications in response to requests, although this is not common practice (see FIG. 2).

The data associated with these updates and transactions are transmitted in conformance with a published set of standards. Data from sensors must be formatted or re-formatted to be in conformance with those standards before entering the Bus. Applications are able to extract data from the Information Store using a query consistent with the standard Because the updates and transmissions are standardised, users can install sensors and construct applications independent of the source of the data those applications draw upon. That is, the sensors and the applications are effectively de-coupled.

FIG. 2 shows the functions of the Bus and the Information Store. The Bus performs the following functions:
1. A user publishes a one-off piece of data to the Hub. In this case, the user simply instructs an application controlling Sensor 2 to send data to the Bus, which transfers it to the Information Store. (e.g. A user sends a message stating the time at which they would like to commence a car-pooling transaction.)
2. The Hub subscribes to a sensor for some data. This can happen in two ways. In the first, the sensor sends the Hub a series of messages, with the correct structure and parameters. If the messages are constructed correctly, the Hub automatically accepts the data In the second, an application associated with the sensor exchanges messages with the Hub to create a subscription for the data. The sensor then publishes the stream of data, but with significantly simplified messages. As each message arrives, the Bus writes it to the Information Store in a format that allows it to be retrieved later. It also publishes the data to applications that have subscribed to it (e.g. a taxi might send time-stamped information about its location to the Hub every 5 seconds and the Hub would relay the data to a map application running on people's telephones) (Note, that the definition of a sensor allows for the possibility that the sensor and the application will be combined, such as when the sensor is a simulation model embedded within a larger application.)
3. The Hub publishes data to an application In this case, the application requests a single datum. When the message containing that datum arrives at the Hub, it is immediately published to the application, which then either transmits it to a user, or places it in a database. (e.g. The Hub sends information about a payment to an application on user's mobile phone, and the application then displays it on a screen for the user to see.)
4. An application requests a datum from the Hub. In this case, the Hub receives the request, and then retrieves the relevant information from the Information Store of an external database and transmits it to the application. (e.g. the user instructs an application to request the time of the last train for the evening, and the Bus interrogates the public transit authority database, retrieves the information, and sends it to the user's application. Alternatively, if the user wishes to know where that train is now, the Bus retrieves the most recent location data from the Information Store and sends that to the User's application)
5. An application subscribes to a flow of data from the Hub. In this case, the user instructs the application to subscribe to the information, and any time information matching the subscription request arrives at the Hub, it is immediately published to the application. (e.g. every time the Hub receives information on the location of the taxi, it automatically publishes that information to the map on the user's mobile phone.) For high-demand applications, a primary subscriber's application may subscribe to the Hub with a secondary Hub, which then makes data available to users. (For example, a map provider might subscribe to real-time data on train locations. The primary Hub would then push the data to their Hub, and they would then push those data to users of their map application)

The Information Store may perform the following functions:
1. It receives data from sensors directly (e.g. a user inputs her demographic details into a web browser which then writes them to the Information Store)
2. It receives data from, and writes data to, the Bus
3. It receives data from, and writes data to, databases or applications

The Hub may have some additional attributes that users find valuable. For instance:
Data may be stored in the Information Store in such a way that they are easy to retrieve, so long as the data request can be framed in terms of a standard search query.
Historical data may be made available to users on the basis of their permission status. So, for example, a bus company might be able to retrieve historical records of the level of crowding of its buses, but its competitors might not, even though the competitor may be able to obtain instantaneous data for one bus if it wished
Subscriptions may be constructed in such a way that every piece of data that enters the Hub has been time-stamped by the sensor using a commonly referenced clock.
The Hub may be constructed in such a way that it constructs a time-stamped log of its transactions, so that historical events can readily be audited.

Hubs based on a Bus and an Information Store have been used in practice. For example, an electronic equities exchange often uses such a hub Furthermore, such hubs have found limited use in transportation, principally in the management of the logistics systems of individual companies. The hub described here, however, hosts data from a wide range of sensors within a transportation domain. As the diversity of sources of sensors increases, so does the capacity for users to develop and implement applications that span across transportation modes or end-uses.

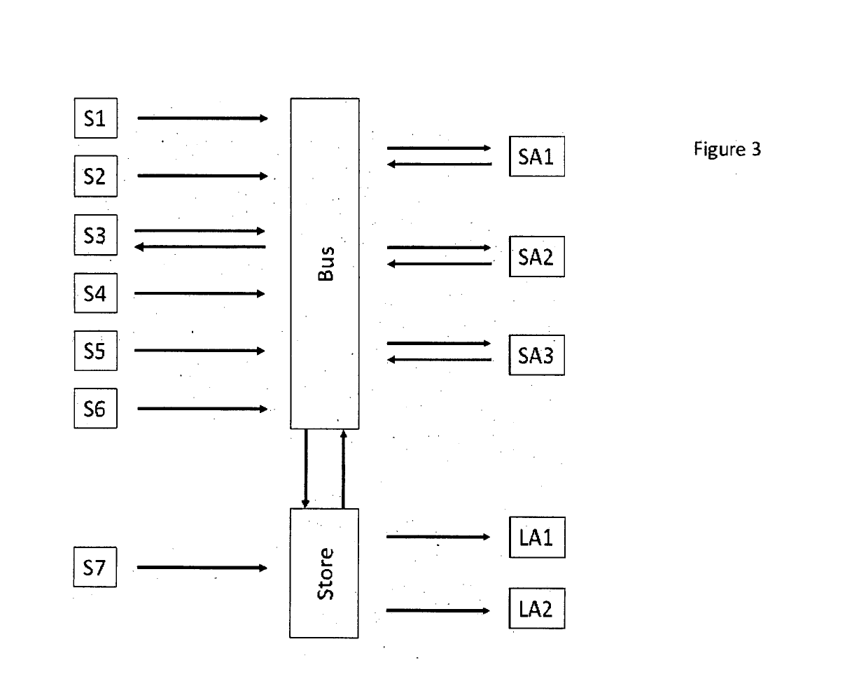

FIG. 3 displays one embodiment of the Hub and associated applications, and sensors. It shows data from sensor sets S1-S6 being provided to the Bus. Again sensor set S1 might be a set of computers in taxis that transmit their availability and location (either directly to the Hub or via the taxi companies dispatch system), while sensor set S2 might be the set of GPS's in suburban trains. These are shown linking to the Bus with a single arrow because they provide data to the Hub relatively autonomously through a subscription (though in reality, there may be two-way communication between the sensor and the Bus to enable the message to be reliably transmitted, confirmation made and non-completed transmissions managed). Sensor set S3 might draw data from a database that contains timetable data for the train network. It is shown connecting to the Bus with a double arrow because it only provides data in response to a one-off request to an associated application. After entering the Bus, all data, other than some data that enter the Hub as a result or an application making a query to an external database, are stored in the Information Store. (For example, results of queries to a timetable database, or a confidential database used to identify users, might not be stored in the Information Store) Data from sensor set S7 are supplied to the Information Store directly, because the data do not have a real-time component. Users might submit demographic information through sensor set S7, for instance. Applications SA1 to SA3 are “push” applications. Whenever data to which those applications have subscribed arrives at the Hub, it is immediately sent out to them. Application SA1 might be driving a set of electronic signs at stations and bus stops, for instance. While labelled as “push” applications, these applications can also “pull” information from the Information Store They are shown as doing so by sending a query to the Bus After the Bus receives the request, those data are extracted from the Information Store and transmitted to the application. Applications LA1 and LA2 are “pull” applications. Application LA1 might measure the extent to which train service providers have been operating their services according to the published schedule Pull applications do not rely on real-time data, and therefore may draw all their data from the Information Store, and so may by-pass the Bus altogether.

In one embodiment, the Hub is hosted across two or more computing “clouds” with each cloud in a different physical location. Such a hub is structured such that all data are replicated at least once across the clouds. That is, either the entire Hub, or parts of the Hub are replicated across two or more clouds This reduces the risk of catastrophic system failure. In the most likely implementation, the clouds are hosted on server farms.

Applications

A broad range of applications using the Hub can be envisioned. Because the data enter and leave the Hub in a standard format, applications are relatively cheap to develop. An application developed for one transportation domain (e.g. car-pooling for Sydney) can be rebuilt relatively easily for another transportation domain (e g car-pooling for Singapore)

The following scenarios capture some of the applications that may exploit the Hub:

Scenario 1: Multimodal Transport Choice

Peg lands at an airport to visit some cousins she has never met. Peg has never been to this city. She has her cousin's address and has decided to make her own way there. She opens up the transport navigator application on her smart phone and enters her destination. The system returns to Peg some options to get to her cousin's address
1. Catch a taxi from the taxi stand 400 m east of her current location. This will cost an estimated $40 and get her to her destination in 33 minutes. However, due to the current taxi line, Peg will also have to wait for approximately 20 minutes for a taxi
2. Request a car-pool from someone nearby. This will cost her $11. If she gets a ride straight away this will take approximately 35 minutes. The system advises that for this location and at this time there is a 90% chance of getting a ride within 5 minutes and there are currently three drivers with “open rides” that may be suitable.
3. Take the airport bus and a connecting train, which according to current times will get her there in 43 minutes and cost her $15. However, unless she is collected by her cousins, this will require a 900 meter walk for the last part of her journey.

Peg selects option 3, and is guided by her phone to the bus stop. The system asks her if she wants a ticket. Peg accepts and the system immediately debits her account, credits the bus company's account, and sends her a confirmation message. At the same time as Peg's ticket details are provided to her, the Hub also publishes them to the driver's handheld device. Peg starts to receive near real-time updates of her expected arrival time at the railway station and the expected connection time to her train, based on real-time locations and traffic conditions published to the Hub. The application invites Peg to have her journey tracked, so her cousins can monitor her progress. She agrees. Peg calls her cousins and lets them know her arrival time and the transaction ID for her journey The transaction ID allows her cousins to track her journey on a map on their home computer.

When Peg arrives at the bus stop, the bus is exactly two minutes away. She takes the bus to the railway station

On arrival at the railway station Peg's phone guides her to the correct platform. The system informs her that her train is exactly 4 minutes away and offers to debit the train fare from her account She accepts An application on her telephone shakes hands with an application in the turnstile and transfers her ticket number. The turnstile lets her onto the platform. The train arrives at the platform and Peg's phone alerts her that is the correct train for her. She is not worried about whether she is on the right platform, catching the right train and going in the right direction. The train leaves the station and Peg sees on her screen the number of stops and the exact time she is expected to arrive at her destination. Shortly after embarking, a ticket inspector asks Peg to confirm her ticket She reads the transaction number, which is listed under the details for this journey. The inspector keys the number into a handheld device and the Hub immediately confirms that this is a valid ticket. Peg is a little tired after her flight and has a light doze on the train. Shortly before arrival at her destination her phone alerts her to get off in two stops. On arrival, her phone confirms that this is the correct stop and tells her which way to walk when she gets off the train.

Peg's cousins have been alerted to the arrival time and are there to greet her. The cousins recognise Peg from the photo on their smart phone.

Scenario 2: Open-Operator Freight

Brighter Sparks Electrical Goods wishes to ship three refrigerators from its distribution centre to customers in three different suburbs. They identify three trucks from those three suburbs that are scheduled to bring goods to near their distribution centre the next day, and book online for them to carry the refrigerators on their return trip.

One of those trucks belongs to Troll and Bridge transport services. In the past, Troll & Bridge operated separate courier and transportation divisions using a proprietary logistics management system. Every day it would receive requests from its clients, and then every night it would schedule its operations for the next day, attempting to minimize the number of vehicles that were sitting around idle or travelling empty. To do so, its staff would enter all data into its system, from the shipping manifests, ship schedules, customs documents, orders, and so forth that it had received. If anything changed during the following day, dispatchers would use two-way radios to change the work of contractors, clients, and company drivers to maintain system efficiency.

Now, Troll and Bridge operates within a city-wide logistics system. All its clients and contractors, along with the port, customs agents, and the railways, place relevant data on to a general database. With each order for shipments comes access to an encryption key that gives Troll & Bridge access to all relevant data it is authorized to receive. This creates a number of advantages in their operations:
They do not have to re-enter data—in addition to saving significant expense, it means data integrity is much greater and all players in the supply chain have access to the same data.
Data are in real time, not from the night before. This means that it is possible to make scheduling and load allocation decisions in real time For instance, if a ship is late into port, it is much easier to track the implications throughout the day's tasks, so as to minimize the disruption.
It is now possible to effectively measure the true cost of each step in the logistics chain, enabling ongoing improvement

Scenario 3: Decentralized Taxi Dispatch

Jeffrey wishes to go home after a night at a bar. He looks on his phone and sees a taxi that is heading towards the hotel. He flags it by touching his screen. Simultaneously, his name and photograph is transmitted to the driver. The taxi is no longer ‘available’ to others and Jeffrey can see its actual progress as it approaches the bar.

Related Applications:

The Hub can be used for all dispatch problems, centralized or decentralized (or a combination). Examples include police cars, fire engines, ambulances, roadside assistance vehicles, and tow trucks.

Scenario A: Authenticated Car-Pooling

Before going to bed, Ryan logs into the car-pooling portal from his laptop. He inputs that he would like a ride to the local university. The application asks if he would like the ride ASAP or has a different preferred departure or arrival time. He inputs a time window for the next morning and receives an upper-bound journey price (in dollars and CO₂ credits) based on a fixed cost plus an amount determined by the distance travelled, the deviation for a driver travelling down the nearest main road, and the assumption there will be one passenger in the car. Ryan accepts the estimate and the application logs the booking.

The next morning Dave gets into his car and places his mobile phone into its cradle. Turning on the car-pooling application, he selects his preferred route to university from his library of previously-travelled routes. In response to the application, he confirms two alternative routes he is prepared to take. It also offers (from a preference file attached to his account) the extent to which he is prepared to deviate from his designated route (in time and/or distance). He is early today, so lie increases the time.

The system presents Dave with a list or riders meeting his criteria, showing their pick-up and drop-off points, the size of the deviation needed from Dave's intended route at the origin and destination, their ratings by other users, system-generated punctuality and “no show” scores, and the fees associated with each rider Dave selects the first rider Riders that would require Dave to drive a different route disappear from the screen and the deviation distances update. He then selects two more riders. Once he has finalized the list, the system offers Dave a route and an estimated travel time—that accounts for expected traffic conditions and his driving history—which he confirms.

Ryan receives an SMS offering him a ride on his mobile phone. He opens the application and finds that if he accepts, there may be one other passenger in the car when he is picked up. A third passenger, requiring an additional deviation of two blocks and three minutes, has also been offered a lift. The other two passengers are also going to the university. A lower-bound price, based on three passengers, is offered. The system also presents Dave's ratings, his vehicle ratings, punctuality scores, and no-show statistics

As soon as Ryan accepts, the system checks his account balance and sends him Dave's registration number and photos of Dave and his car. Ryan recognises Dave from his Physics class. Dave's phone beeps and confirms two acceptances. (Ryan will be charged an intermediate price.) The system directs Dave to Ryan's house.

Ten minutes later, Ryan receives another message saying that only two passengers have accepted a ride, and asking him if he is willing to accept a third. The map indicates that Dave will need to deviate significantly from the previously agreed route. Ryan is in a bit of a hurry so he vetoes the third passenger.

When Dave is 10 minutes away, both appear on maps on the other's phone and the estimated arrival time updates periodically. At this point a dedicated VOIP service is also enabled. When Dave is two minutes away, Ryan's phone beeps and he heads out the front door

When Dave arrives, the system asks Ryan to confirm that the registration information matches the vehicle and that Dave matches the photo. The system also asks Dave to confirm that Ryan matches his photo When both have confirmed, the transaction is opened, and Dave is directed to the second passenger's house.

When they reach the campus, Dave drops Ryan and the other passenger and goes to park the car Because they have reached the destination and the system has detected that Ryan's mobile phone is no longer with Dave's, the transaction is closed and the funds and CO₂ credits are transferred from his account. Ryan is asked to rate Dave, and receives a discount on his fare when he does so within a prescribed time. When Dave parks the car, he rates Ryan and the other passenger, and the funds and credits are transferred into his account Before he exits the application, he registers the location of his car with the car-pooling application.

At the end of the day, Dave is finishing up his last lecture and knows he is leaving soon He opens the application, enters the estimated departure time for his journey home, and selects his route. Ryan, who is finishing off some work in the library, decides he would like a ride home as soon as possible. He opens up the application and indicates this.

The application matches them, shows Ryan the location of Dave's car, and gives him an estimated time to walk to it. He confirms, and the ride is booked. Ten minutes before it's time to leave, his phone beeps, and he starts to walk to the car. He can now see Dave and the car on the map. He sees Dave is ahead of him, but not so far ahead that there's a risk of Dave cancelling the trip because Ryan doesn't show. They arrive at the car and Ryan puts his bag in the trunk

On the way home, they decide to stop for coffee and turn off the designated route. They forget to pause the car pool transaction. As they sit in the café, Dave's phone beeps the emergency beep and he enters his PIN number to say all is O K. Ryan's is in the trunk of the car, so he doesn't enter his. This escalates the situation, and the Police switch on a camera inside the car to see what is going on. When they see the car is empty, with the ignition off, they call Ryan's phone. Getting no answer, they call Dave's. Dave explains they have stopped for coffee and puts Ryan on the phone. Ryan confirms he is fine and enters his PIN in Dave's phone. He undertakes to enter his PIN into his own phone within five minutes. They go back to the car and he retrieves his phone from the trunk. He enters his PIN and the camera comes on again He confirms that he's O K to the camera

Dave drops Ryan at home, the transaction is closed, and money and CO₂ credits are transferred.

A Related Application:

A related application to the general car-pooling case is car-pooling for people of limited responsibility, such as schoolchildren. In this case the general procedure would be the same, except that an external registered user (e g a parent or guardian) might have control over the user's account. This control could be exercised in different ways:
The external user might restrict the characteristics of the people who can drive the passenger (e.g. women only, only people with unblemished driving records, etc.)
The external user might restrict the people who can drive the passenger to a specific list of people known by the external user
The external user might have real-time veto (or approval) rights over any lift the passenger accepts
The application might give the external user the capability to monitor the trip from start to finish on a map.

Similarly, the registrar might create a particular class of drivers who are authorized to car-pool such passengers (e.g. people with children at a school within a certain radius of the child's school).

Scenario 5: Ship-Port-Customer Supply Chain Management

When the manufacturer loads a container of electrical goods to ship it to a department store, it loads the goods on pallets according to instructions from the store. Each pallet is bar-coded. Some pallets are designated for individual stores, while others are destined for the warehouse. The manufacturer uploads the manifest (by pallet), the locations of the pallets in the container, and the container number into a computer system. As the container moves from the factory, to shipping the port, to the ship, to the receiving port, to a truck, and then to the Department store's warehouse, it is scanned, and the computer systems of the Customs, the Port, the Stevedores, the shippers, and Department store itself are updated instantaneously. Before the ship arrives in port, Custom's officers clear the goods in this container, update the electronic record to reflect this, and notify the Stevedores of which other containers they want to inspect. Meanwhile, the Stevedores develop an unloading plan. When the ship is two hours from port, the Stevedores notify the shipper with a crane location and a fifteen-minute un-loading window At the same time, an SMS message is sent to the drivers of the trucks the shipper has designated. The containers designated for inspection are stacked in one area. This container is loaded directly onto a waiting truck. The truck drives it to the Department store's warehouse. As soon as it enters the warehouse its contents are automatically transferred from the manifest into the Department store's inventory system. The warehouse staff check all the expected pallets are accounted for. From the container, some pallets are moved to the shipping bays to be sent to individual retail stores that night, while others are stacked in the warehouse The pallets designated for the retail stores are checked at the stores, while the rest are checked at the warehouse.

Scenario 6: Short-Term Car Rental

Flexrent car services provides a car rental service where people can rent cars for as little as two hours. Using her mobile phone, Rebecca is able to locate a car, parked at a parking meter, complete the rental transaction, and download the code for the digital door lock and ignition switch.

Scenario 7: Evaluating Service Capacity from a Distance, with Multi-Modal Choice

Danny needs a haircut, and cannot decide whether to take a taxi or a bus to the barber. The taxi is faster, but more expensive Using the computer on his desk he obtains an image of the inside of his barber's shop and sees it is not crowded. However, a predictive model in the application suggests that demand will rise sharply at 4:00 p.m. Danny presumes this represents an after-school rush. He is unsure whether the bus can get him there on time, so he checks with a journey-planning program. It indicates the expected trip duration and fares for the bus and the taxi. However, it also suggests two options he hadn't considered. He can walk to the station and catch the train Alternatively, he can walk to the station and rent a bicycle. It tells him that there are currently two bicycles available on the rack outside the station. He looks out the window and it is overcast. He clicks an option and the program tells him the probability of rain along his bicycle route in three time windows over the next three hours. He decides to hire a bicycle. He clicks on the application to reserve the bike. He then walks to the station and confirms his identity by entering a PIN into an application on his mobile phone. The rental transaction is opened. He rides to the barber's, gets his haircut, and rides back When he gets back he locks up the bike As soon as the lock on the rack closes, and the rack reads the tag on the bicycle, and the rental transaction is closed and the cost of the hire is deducted from his account.

Related Applications:

A core element of this scenario involves observing congestion at a remote location (the barbershop). This capability can be extended to observing any measured state variable at any location connected to the network. For example, it would be a straightforward extension to produce a map of petrol stations with their current prices shown. An extension of that would be the capacity to roll a mouse over a petrol station's icon to bring up a graph of historical prices.

Scenario 8: Transport Planning

Tanya the transport planner is trying to decide how to respond to complaints of overcrowding on buses on a route that intersects several tramlines. She downloads one year of patronage data for the bus route and uses that to construct estimates of the level of crowding, by time of day, for the year. She looks at the crowding graphs and finds, to her surprise, that the bus is generally not crowded, but had severe crowding, starting at the intersection with the second tram line, on fifteen mornings during the year She downloads the schedule conformance data tor that tramline for those 15 mornings, and selects at random the data for 15 other mornings. She discovers that there was an average of three extra tram cancellations on each of those mornings. She looks up the crowding data for that tramline for the 15 mornings when there were the cancellations, and discovers that the trams were overflowing until three stops after the intersection with the bus line. At that stop, which was outside a school, a large number of people alighted. She downloads the reasons for the cancellations from the trams' maintenance records, and discovers that ten different trams had mechanical problems. She decides to investigate maintenance practices at the tram depot.

Scenario 9: Factory Throughput Management

Phil is a production manager in a factory. His company produces electronic circuits and cases in which to house them. While they use materials requirements planning software to create a daily schedule, they do not have a good system for real-time shop floor control. They have been using “kanban” cards, which move batches of materials between process steps. So, Phil sets up sensors of various kinds on machines and processing stations. They measure whether the machines are processing or idle and whether there is a queue of items waiting to be processed at the machine. This information is sent to a real-time Hub, from which a controller can effectively send parts to the various machines in order to achieve maximum machinery utilisation and throughput. The controller function was initially a human decision maker, but this step has now been automated and an algorithm processes the data.

Related Applications:

A very similar application could be used to manage the flow of patients in a hospital. For instance, patients needing x-rays or physiotherapy could be called when needed, on the basis of sensor data, rather than waiting in lines because the services are behind schedule.

Scenario 10: Contingency Planning on Public Transport

Penny likes to be at work by 8:30 am. Normally, she catches the 7:32 am train to work from her home station to the central station, arriving at 7:56 am. She then has a 5 minute walk and 1 minute wait for the train which stops out the front of the station at 8 01 am That train takes her through to the station near her work, arriving at 8:20 am. She then has an 8 minute walk to her office and arrives at 8:28 am.

Penny has entered this information into an online application One morning at 7 05 am she gets a message that her usual train has been cancelled. The application gives her the following options:
Catch the same train at 7 32 am and wait for the next train at 8 11 am, meaning she will arrive at work at 8:33 am
Wait and catch the next train at 7:44 am. This is an express and will get her to the central station at 8:08 am to still get her on the 8:11 am train. However she is warned she only has 3 minutes to get to the train stop to catch that train.
Catch on the 7:20 am train, getting to the central station 7:44 am, connecting with the 7:48 am train, getting her to work at 8:16 am.
Request a car-pool to her destination. The system checks those available and finds a few possible matches that are able to get Penny to her destination before 8:30 am. Telling her the cost of $6.00. If she selects this option, the system will attempt to confirm a ride. If it cannot find one, she still has the other choices.
Catch a taxi to her destination It tells her the estimated required pickup time to arrive on time, the number of taxis within 5 km at the moment, and at the required pickup time yesterday, and the estimated cost for the trip.

Scenario 11: Disaster Management and Emergency Response

A major earthquake devastates a city, destroying a major hospital and a major fire station and cutting land-based communications to a big portion of the city. The city's disaster plan is severely compromised However, the city's disaster management system is connected to an application that makes is possible for everyone involved in the emergency to see, on a map, the locations of all emergency vehicles, the available capacity of all the hospitals, the size of the bottlenecks in the emergency rooms of each hospital, current commitments of people to those hospitals, and current estimates of need for police, ambulance, fire trucks, and other personnel at key locations. Furthermore, embedded within that application are a set of optimization routines that can be run—every few minutes if desired—to optimally allocate resources, given the data at hand. A core group in a central control room improvises a new plan and negotiates with the people in the field. People in the field, aware of the emerging plan, and aware of their local situation, suggest local improvisations. Once they are approved, they enact them

Notes, and Related Applications:

This scenario applies to all large-scale emergency management situations. In these emergencies, the Hub overcomes the same set of problems as with transportation in general. However, in emergency response, the problems with the present art lead to problems that are much more acute. A common problem in the management of large-scale emergencies is that people's lives are imperilled because decision-makers and field operators are often working with incomplete or wrong information. Not only does this mean that people make poor decisions, but people often make poor assumptions about the situation, leading to very poor decisions. The scenario illustrates the Hub creating a number of advantages for disaster response
While location data alone can potentially be provided and updated automatically using the current state of the art, the Hub makes it possible to manage a diverse array of information (e g vehicle locations, number of unallocated beds in hospitals, task logs, fire front location, wind and temperature data etc.). This saves valuable labour and attention, and gives people reliable data.
Decisions can be coordinated up and down the hierarchy and across the multi-organisation structure of emergency services by a single ‘information nervous system’.
People in the central control rooms of different organisations (fire, police, army, etc.) can communicate with each other knowing that everyone is working from the best available information and the same information.
People with local decision-making responsibilities can make decisions on the basis of full information. For example, in a recent Australian fire, several people died because an emergency worker closed a road on the basis of out-of-date information. That road was safe and the alternative route was deadly
People working locally and central coordinators can communicate knowing that everyone has full information.
Fire engine crews, ambulance crews and others can see where all the other emergency services are located and what tasks they are engaged in and assigned to do next. Demand for such services can be logged and displayed.

Large-scale emergencies vary however In some, such as bomb blasts, multi-vehicle pile-ups, and earthquakes, the underlying situation stays reasonably static, and so it is possible to optimize the response as more information emerges. In others, such as floods and wildfires, the underlying situation often evolves too quickly for computerized optimization to be of much value. In such a situation, simply giving everyone, including the citizens in harm's way, up-to date information in an easy-to-understand format (such as a map showing the fire front, projections of its path, weather readings, which roads are opened and closed, and the locations of all personnel) facilitates effective management

Scenario 12: High Complexity Logistics

A logistics officer for military war games manoeuvres must keep 1000 soldiers fed, their vehicles fuelled, and their supplies of munitions up to date. An application on his computer allows him to “feed forward” where different vehicles plan to be at a given time, and constantly updates this on the basis of their current location, progress against their plan, and the experiences of others in a given location. It also gives him a prioritized list in terms of the current state of fuel, food, and munitions, for each vehicle This list also updates in real-time. Finally, it allows him to run optimization routines that he can use to work out how to organise the feeding, re-stocking and refuelling operations to best keep troops on the move. On the basis of the suggestions from the application, he plans the movement of feeding, refuelling and re-stocking operations and changes those plans as the situation evolves.

Application Modules

Underlying the applications described in the scenarios is a set of building blocks, which we call application modules. Each of the applications described above would contain within it one or more of those modules. Likewise, when enacting the scenario, an actor might invoke two or more applications in a series (see scenario 7 for instance). Consequently we describe the individual modules in detail with the understanding that a given application will be built from one or more modules, and a given scenario will require one or more applications. By using the term ‘module’ we do not mean to imply ‘plug-and-play’ compatibility between the modules or that the module will be constructed the same way in every application. The specific ways in which the individual modules are constructed will depend on the specification of the application, while the specific ways in which the applications are constructed will depend on the needs of a given actor. Furthermore, when constructing an application, an application developer may need to invoke functions other than captured by the modules described here. Likewise, some of the scenarios above require actions beyond those that can be provided by applications on the Hub. That is, the set of modules described below is not exhaustive and should not be constituted as such

Module 1. Registration of Users

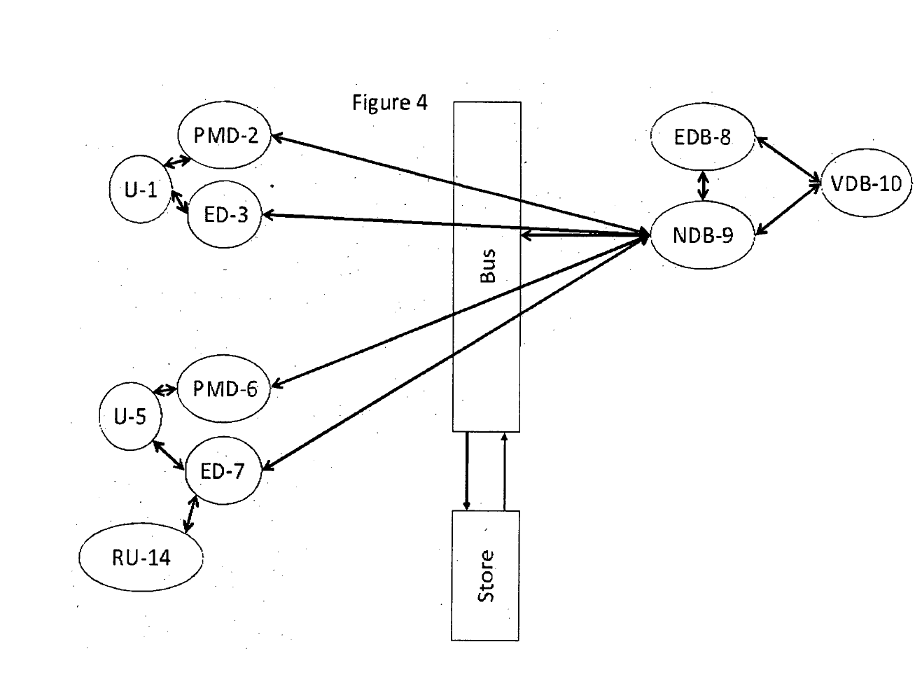

If a user is going to enter into a financial or other transaction with another user of the Hub, there may be a need to register them. Registration processes are implicit or explicit in scenarios 1, 2, 3, 4, 5, 6, 7, 9, 10, 11, and 12 above. Depending on the scenario, the registration process may be more or less complicated. For example, in scenario 3, it is probably sufficient to register just the identity of Jeffrey's mobile phone for him to be able to hire a taxi. In scenario 4, however, in which the system needs to assure the security of the car poolers and in which a financial transaction will be executed through the Hub, the registration process is significantly more complex. The description below is based around a person registering for a car-pooling service to provide some context Simpler cases and variations on the complex case can be inferred from the complex case. The case is represented graphically in FIG. 4.

All registration systems require a registrar In the case of car-pooling, it may be a local government authority such as the registrar of motor vehicles, the employer of the users, or some other organisation that has access to an existing database that contains pre-existing information about potential users. (That database is indicated by symbol #8 in FIG. 4). Such a registrar may choose to store registration information in their pre-existing database (such as by augmenting a drivers' licence record to indicate that someone is a qualified car-pooling). Alternatively, they may choose to create a new database (NDB) (#9), or to store the data in the Information Store on the Hub (Store).

In a carpooling application, and many other applications, the registrar may wish that the users be unambiguously identified. Unambiguous identification may make it possible to trace a registrant at any time before, during, or after an event. If the registrar were the registrar of motor vehicles, this might be achieved by linking users' car-pooling registration to their driving licence records or their age identity card records (for people who do not have driving licences). If neither were available, a new record could be created within that database (#8). The identification criteria and methods may be the same as those used for drivers' licences and age-identity cards. If the registrar were an employer, then the registration could be linked to employment records (also #8). If the registrar did not have access to any previously validated database, then it may need to set up a system for registering drivers and riders in such a way that users of the system and relevant external parties were satisfied that they could positively ascertain the identity of a registrant

Methods for registering users of a system are well established in the existing art. User number one (U) (#1) might register using an application on the device that carries his or her personal mobile sensor (PMD) (#2) or one carrying an external sensor (ED) (#3) such as a program on a personal computer or by some other means (e.g. such as filling out a form and sending it in). User number two (U) (#5) might similarly use a personal mobile device (PMD) (#6), an external device (ED) (#7) or some other means. The Hub may mediate communications between the user and the registration database, or the process may by-pass the Hub entirely. In FIG. 4, the process is shown with the users writing to the new database (#9) directly.

Once users are registered, the registrar may choose to create an account for the user. The account may reside as new fields within an existing database (#8), in a new database (#9), of in the Information Store. The account may contain pointers to information in other locations For example, an account in a new external database (#9) may contain pointers to identity information in a driver-licensing database (#8), financial information at the user's bank (#10), and rating information about previous car-pooling performance in the Information Store.

Once the account is created, the registrar may perform a background check on the registrant. The registrar may do this by searching various verification databases (VDB) it is authorized to search (#10). For instance, it may ascertain whether a registrant has been convicted of a violent crime, has been convicted of particular driving offences (e.g. culpable driving, driving while intoxicated), or has a poor driving record (i.e. many demerit points). This information might be stored in the registrant's account in the database. It might be used to preclude the registrant from participating in the system, to shape their privileges within the system, or to provide information about the registrant to potential transaction partners. Background checks may be performed on a number of dimensions, depending on the application in question. For example, a registrar might check the credit-worthiness of an applicant who is going to be provided with credit

In addition to verifying the identity of the applicant, the registrar may wish to gather other information and store it in the user's account. This information could be gathered from the user directly, obtained from another source, or accessed using a pointer to the other source Examples of this sort of information include:
Information that one user of an application can use to select or positively identify another user. Such information might include a photograph of the user (or a pointer to the user's drivers' license photo or employment photo), a signature, a voice recording of the user, a spectral analysis of the voice recording of the user, a fingerprint, or an iris scan.
Information about items associated with a user. Such information might include a user's vehicle registration number, model and colour, and a photograph of their car
A personal identification number (PIN), or multiple PINs, that can be used to facilitate the security of users and transactions.
Information about the user's historical experiences with the application and associated activities. For example, in a car-pooling scheme, users might rate each other. They might provide feedback on the person's demeanour or other aspects of their behaviour, and the quality and cleanliness of their car (for drivers), or any other relevant information. The system might also generate ratings on their punctuality (for riders and drivers), their cancellation rate, their no-show rate, or other variables. The account might contain a record of all the ratings a given user has given and received In addition, it might keep a library of the routes a given user has travelled, and/or the origins and destinations of a given user's trips.
The user's financial records within the application. This could be as simple as having a pointer to an external financial services provider Alternatively, all or part of the financial account might be held within the system. Such an account could operate in terms of real currency (e.g. dollars), some other externally negotiable instrument (e.g. CO₂ credits), an endogenous currency (e.g. car-pooling points), or some combination. The endogenous currency might be exchangeable for real currency at a fixed or a variable rate.

The registrar may choose to construct the database in such a way that one registered user (RU) (#14) has the capacity to constrain the choices of other users. For example, for a car-pooling application, a parent may choose to constrain the account of their child so that the child can only accept rides from female drivers with perfect driving records

For purposes of clarity of presentation in the figures, and simplification of the text in the remainder of this document, the rest of this document is based on the following assumptions (where relevant)
Validated identity-related data about a user are stored in an external database (#8). For instance, this might be a user's driver's licence information with some extra fields added.
Other data that are relevant to their account, but not what they do with the account are stored in the new database (#9). For a car-pooler this might include their library of preferred routes and summary statistics on the way other users have rated them.
Event-specific data relating to a particular user (such as data tracking a particular ride, and ratings for a particular ride) are stored in the Information Store.

As should be clear from the text above, these data could all be stored in different places, and many of the data stored in the new database (#9) will also be stored in the Information Store as a matter of course when they pass through the Bus on the way to their destination.

Module 2. Retrieving Historical Data from the Information Store or Retrieving Data from an External Database

These functions are implicit or explicit in all scenarios. They are core functions of the Hub and were discussed above.

Module 3. Choosing Between Transportation Modes

A number of the scenarios involve choosing between transport modes In scenario 1, the choice is implicit with the application choosing between modes in order to put together a journey plan for the arriving tourist. In scenario 7 it is explicit. The application gives Danny a number of choices for getting to the barber. In scenario 10, Penny must find a new way to get to work There are many ways these choices could be generated This is one alternative
The user inputs a proposed origin and destination.
For each transport mode, the application generates a set of single or multi-modal routes and transportation methods using established techniques. It uses a set of criteria (e.g. total distance travelled, total number of interchanges, total cost etc.) to select a plausible subset.
The application then uses established techniques to reduce the subset on the basis of schedule information or speed estimates (e.g. for walking and cycling). For example, for each mode (except walking), it might eliminate all journeys that are scheduled to take more than 150% of the quickest involving that mode
If the proposed trip were far in the future, the application would use schedule information to construct as set of alternatives, which it published to the user via the Bus.
If the proposed trip were in the near future, the application would instruct the Hub to extract relevant information from the Information Store or subscribe to relevant data from sensors (e.g. current location of a scheduled train (from which an application would estimate the bus's arrival time at an interchange point), number of taxis in an area, number of available bicycles on a hire rack, etc.). Using those data it would check that the routes are still feasible, and modify those that are not. (e.g. if a train is running late for a connection, find the time of the next connecting train).
The Bus would then publish the results to the application, which would present them to the user.

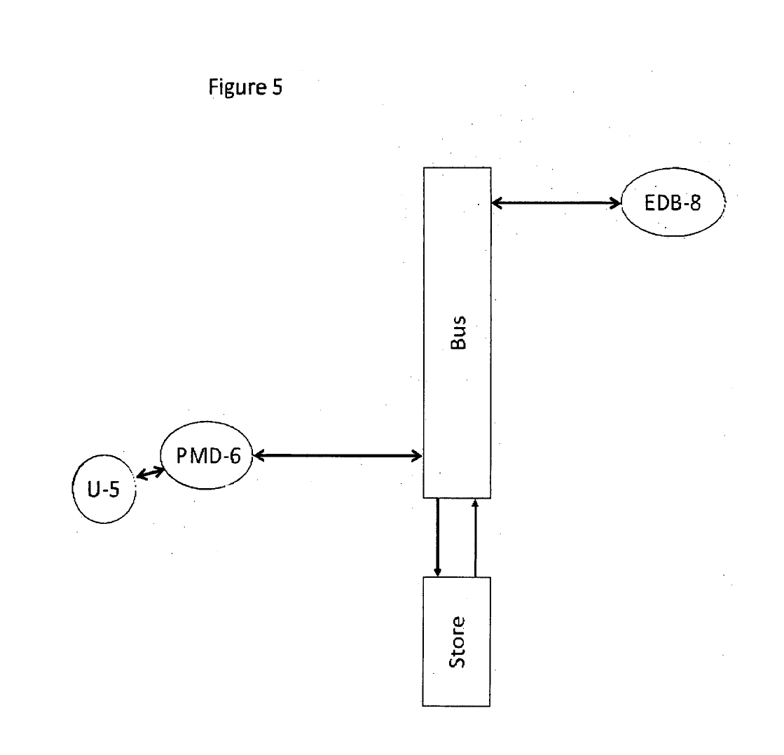

FIG. 5 shows the Bus communicating with an external database (for schedule information) and the Information Store, and then relaying the results back to an application on the user's device. (Information about the availability, location, etc. of various trains, taxis, car-poolers, bicycles, etc. would already be in the Information Store.)

Module 4. Opening and Closing a Service Transaction

A transaction, such as a car-pooling ride or a taxi-fare must have a specified opening point and closing point. Opening may require two steps. First, the Hub initiates the transaction, then, the parties to the transaction consent to its opening.

The Hub may open the transaction after:
One party manually sends it a message.
Two sensors come into proximity with each other (such as when a rider gets into a driver's car). For example, when the two devices shake hands, an application associated with one of them might send a message to the Hub to commence the transaction. Alternatively, an application might detect that GPS signals are coming from the same location and send a message to the Hub.
A vehicle-mounted sensor or personal mobile sensor comes into proximity with a particular location (such as when a driver arrives at a rider's house). This triggers a message to the Hub.
When a sensor passes a trigger (such as coming into proximity to a sensor on a train) a message is initiated to the Hub, and it sends the party a message inviting them to participate in the transaction (e.g. being offered a two-hour or 24-hour ticket).

Consent may be achieved when
The counter party (the one who did not initiate the transaction) also manually sends a message to the Hub;
The counter party's sensor automatically sends a message to the Hub (e.g. in response to tripping a trigger).
The counter party enters a PIN in the first party's sensor, triggering a message to be sent to the Hub;
An application triggers the Hub to send a message to one or all the parties to the transaction, and they acknowledge the message, with or without a PIN. This triggers a reply to be sent back to the Hub.
The transaction commences without a confirmation step by one or both parties (such as when a passenger comes into proximity to a sensor on a train and it automatically initiates a fare transaction).

Transactions can be closed by essentially the converse means. Closing also requires initiation and may require confirmation.

Closing may be initiated by (messages to and from the Hub are omitted in these descriptions but ale parallel to those above)
One party initiating the closure manually.
Two sensors ceasing to be in proximity with each other (such as when a rider gets out of a driver's car).
A vehicle-mounted sensor or personal mobile sensor coming into proximity with a particular location (such as when a driver arrives at a destination), or ceases to be in proximity to a particular location (such as when a driver leaves a destination).
The Hub (or a local computer) sending a message to a party inviting them to close the transaction, on passing a trigger (such as coming into proximity with a sensor on a train).

Closing may be confirmed by:
The counter party also manually attempting to close the transaction (if the first party has initiated the closure manually);
The counter party entering a PIN in the first party's sensor (if the first party has initiated the closure manually);
The Hub sending a message to one or all the parties to the transaction, and they acknowledge the message, with or without a PIN.
The application closes the transaction without a confirmation step by the counter party.

Alternatively some of the steps might take place locally, with a confirmatory message being sent to the Hub. For example, a train fare might be paid as follows: When a sensor passes a trigger (such as coming into proximity to a sensor on the train) a local computer sends a message inviting the passenger to participate in the transaction. When the request is accepted (probably automatically), the computer on the train opens the transaction and stamps it with the time and location. When the sensor passes the trigger again (i.e. alighting the train), another local message is created with the time and location. At a subsequent time, a message is sent to the Hub with the commencement time and location and the closure time and location.

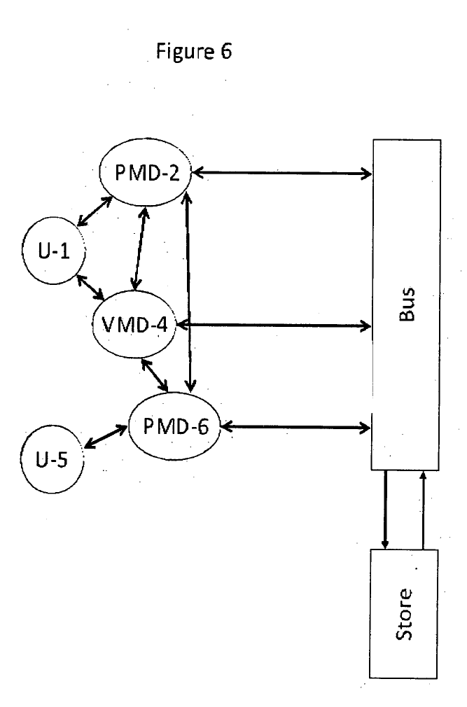

FIG. 6 shows the various interactions between the local sensors, the Hub, and the Information Store needed to commence and close a transaction. Introduced in this figure is the vehicle-mounted sensor, which resides on the vehicle-mounted device (VMD) in user number one's car (#4).

Module 5. Executing a Financial Transaction

A financial transaction can be executed two ways.

The Hub may execute the transaction directly (e.g. it could subtract CO₂ credits from one user's account and credit them to another.)
The Hub may publish the relevant information to an external party, such as a financial services provider (e.g. PayPal, Visa), or a purchaser of CO₂ credits, who would execute the transaction and send the results back to the Hub. The Hub could then forward the data to applications on the users' devices.

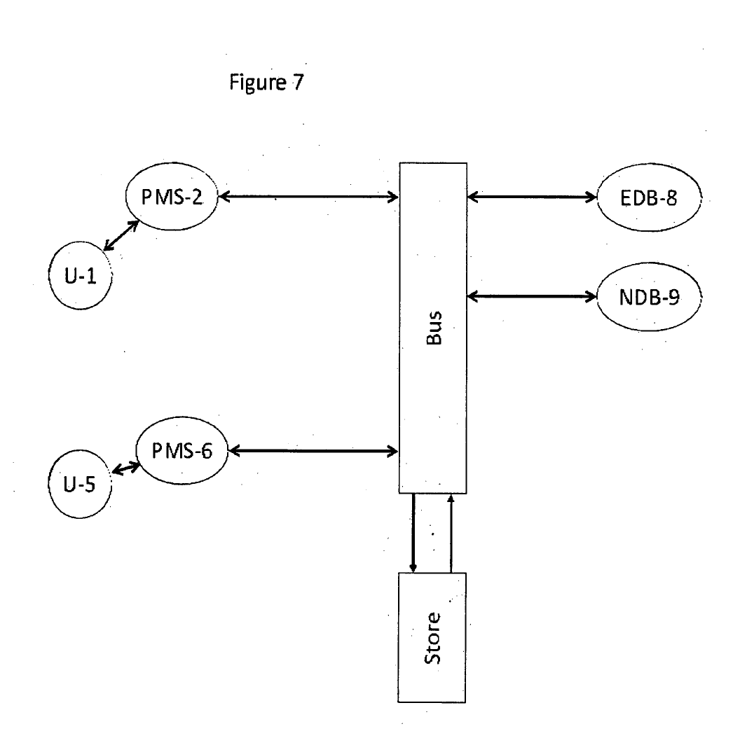

FIG. 7 shows the Bus receiving a request for a transaction from two car-poolers, transferring CO₂ credits between their accounts in the new database (#9), and transferring money from one to the other through an external financial services provider. The Bus performs the CO₂ credit transaction directly, transferring the balance from one account to the other For the external transaction, it sends a request to an external financial services provider, who executes the transaction and sends back the results. The Bus then forwards the results to applications on the users' devices and/or updates their accounts. If a user were topping up their account, an external device might be implicated. If they were paying a taxi fare, a vehicle-mounted device might be implicated The financial information might be held in an external account with a pointer in their account within the system. Notwithstanding, the principles remain the same.

Module 6. Observing the State of a Variable at a Remote Location

Scenarios 1,3,4,5,6,7,9,10,11, and 12 all involve situations where a user uses information about a state variable in another location in order to make a decision. For example, in scenario 7, Danny wishes to know how many chairs are empty at the barber's shop. In order to bring this information to the user:
The Bus subscribes to the data coming from the sensor that generates the data, or the sensor publishes the data to the Bus.
An application subscribes to receive those data. Alternatively, the application requests the most recent datum from the Information Store.
The Bus retrieves the most recent value of the required information from the Information Store and publishes it to the application, or it publishes the information to the application on arrival.

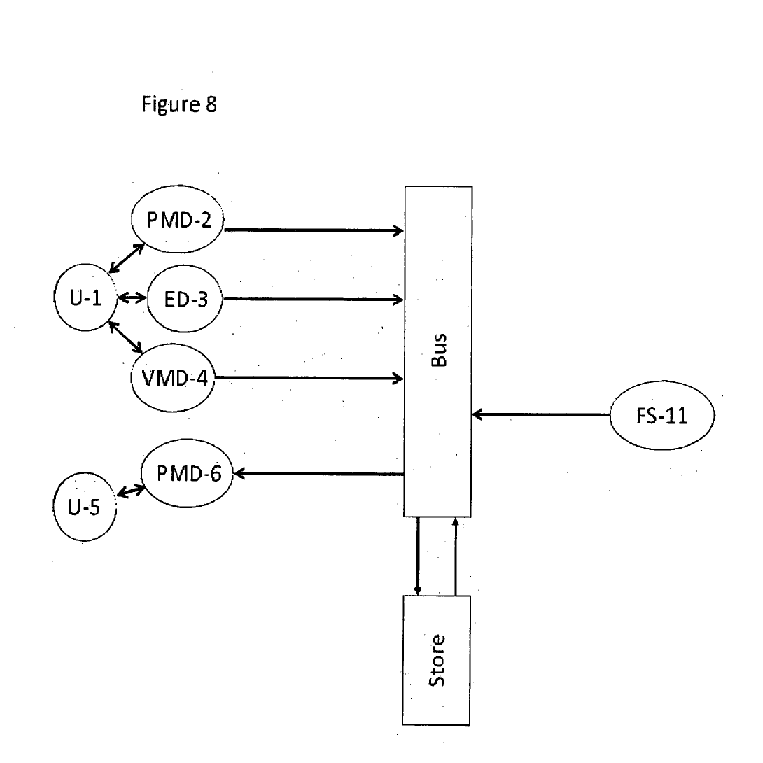

FIG. 8 shows user number 2 (#5) receiving information to an application on their personal mobile device (such as a map on their smart-phone). They may retrieve data from a sensor associated with user number 1 (#1) (i.e. sensor #2, #3, or #4) (where #4 is the vehicle-mounted sensor on the vehicle mounted device on a vehicle user #1 controls (such as a car, a taxi, a train, or a bicycle)), or from a fixed sensor (FS) (#11) giving information such as the number of bicycles on a rack or the number of empty tables in a café.

Module 7. Service Provider Registers an Intended Route, Schedule and/or Other Preference

If someone is going to offer a transportation service, they may wish to constrain the service they offer depending on their external needs. For example, towards the end of a shift, a taxi driver may only wish to take on rides in the general direction or the depot (scenario 2) Similarly, a car-pooler (scenario 4) or someone wanting to take freight on a return trip (scenario 3) may only be prepared to go a certain distance out of their way, or to pick up within a certain time window. Therefore, the service provider's (driver's) intended route, time, or other preference may be presented to potential users by the Hub for manual or automatic comparison to their intended route, time, or other preferences. Depending on the scenario, the information presented may be some combination of
Times
Origin and destination and an acceptable deviation from a path between them.
Whether or not the driver will only drop off at their destination. (For example, a university student might only be interested in giving rides to other people going to the university.)
A particular route.
An acceptable set of routes
Acceptable types of riders (For example a university student might only be interested in giving a ride to other students.)

Depending on the scenario, the driver may wish to nominate the destination as an area rather than as a point location For instance, a car pooler might not know where they will be able to drop people off before they park on a university campus or at an airport, or may be prepared to drop people anywhere on that campus/airport.

While there are many ways of capturing possible routes, times, and preferences for presentation to potential service consumers, the following multi-step process represents one possibility. The first step is for the user to input the route, times, or other preferences into an application that transmits it to the Hub. To do this:
The driver, or his/her agent might input the data manually. For instance a public transit authority might type in its timetable, or a driver might type a route, step by step.
The driver, or his/her agent might trace a route using a stylus on a map interface.
The driver, or his/her agent might enter the origin and destination for the trip on a map interface, and the application could suggest a route, or several routes. The driver might then select the route/s they are prepared to take and also designate their preferred route
On entering their vehicle, or at any point during their trip, the driver could enter a destination into an application on their personal mobile device, or a vehicle-mounted device, and the application could suggest a route/some routes (possibly after interacting with other applications and/or the Hub). The driver might then select the preferred one.
A sensor could track the route as the driver drives it, and then transfer the data to the Hub. An application could extract the data from the Information Store and convert it into a route.

In the second step, an application may store the information in the user's account (on database #9). It may also store it in the Information Store, independent of the user's account (e.g. if the route is going to be used just once, and immediately).

In the third step, if the route/time/preference is stored in an account, then it may not be the only alternative stored there. As such, the driver agent may select which of the stored routes/times/preferences they wish to offer to potential service consumers, or a priority list. For instance, a user might have a library of stored routes in their account, and the application might ask them to select one of them. To do this, the application might present a list of routes/times from the library to an application on one of the user's devices, and the user might select one or a number of items from the list, or prioritize them. Depending on the way this choice process is constructed, it may pass the information through the Information Store and the Bus, or it may by-pass them completely.

A preferred route and/or preference is now within the Information Store, or a timetable is now within an external database, ready to be called when demanded by a potential service consumer (see module 9).

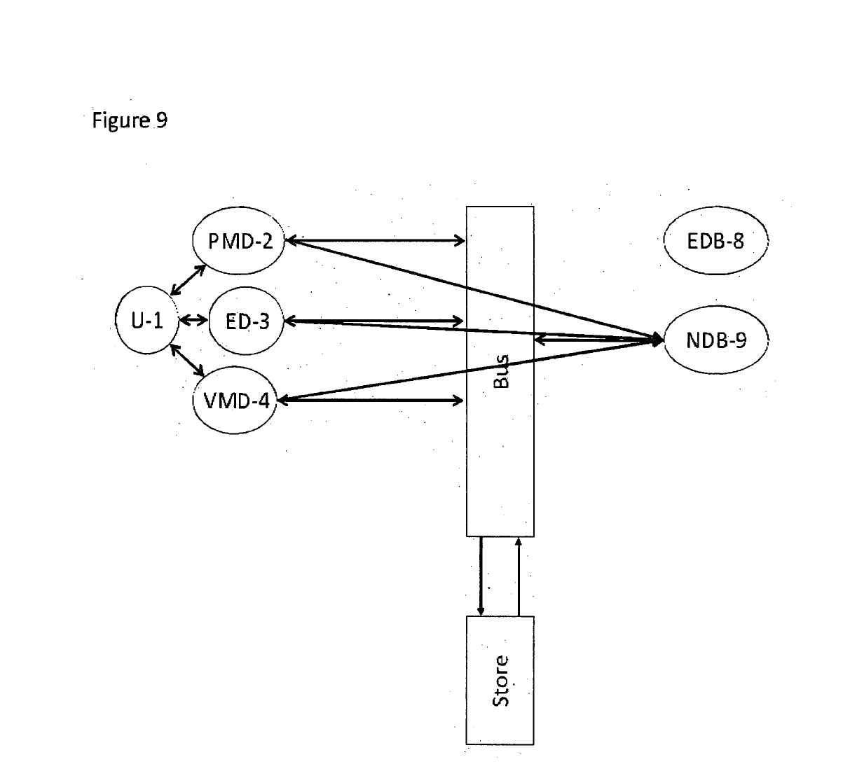

FIG. 9 shows an external database (#8) containing data (e.g. time-table information) ready to be transferred to the Bus (The figure does not show data being input into the external database (#8). The figure also shows data being transferred from the sensors of a user (#1) (i.e. a personal mobile sensor (#2), a vehicle-mounted sensor (#4) and an external sensor (#3)) to their account in an external database (#9) directly and via the Bus. (Some applications might transfer the data directly, while others would go through the Bus.) Data that enter the Bus may also be transferred to the Information Store. Finally, the figure shows some routes/times /preferences (or index information about those routes/times/preferences) being transferred from an external account to the Information Store, and from the Information Store to the user (via the Hub) so that the driver/agent might select between them. (Direct transfers between the databases and the Information Store or the sensors and the Information Store (i.e. not via the Bus) air plausible, but not likely in this situation. If an application draws on the capabilities of the Information Store, it is likely to also draw on the capabilities of the Bus. Therefore, direct transfers are not shown in the figure) Interactions with external databases to download maps etc are not shown

Module 8. Service Consumer Registers a Desired Route and/or Time and/or Preference

If a user wishes to use a transport service to move himself or herself or an object to another location, they need to register that need and attributes of it, such as a desired route, time, and/or travelling preferences. This module is implicated in scenarios 2, 3, 4, 6, 7, 10, 11, and 12. Again, depending on the scenario, this may be more or less complicated. Someone moving freight (scenario 3) or trying to work out which transportation mode suits their needs (scenario 7) may wish to enter only their origin and their destination. Someone sending their children on a car-pool may wish that only certain types of driver transports their children (e.g. parents of children at their school or one nearby). That is, the information to be input may be some combination of
Times
Origin and destination and acceptable deviations from the origin, the destination, or a path between them. (e.g. how far a car-pooler is prepared to walk to pick up a lift.)
A particular route
An acceptable set of routes
Preferences about the service offered

As with the ride giver, registering this information can be done many ways, of which the following three-step process is one possibility.

In the first step, the potential service consumer enters their needs into the system:
They could type in a route (or acceptable time windows or other preferences) step by step into an application attached to an external sensor.
Using a map interface on personal mobile device or external device, they could enter the origin and destination for the trip, and the application, possibly after interaction with the Hub, other applications, and databases, could suggest a route, or several routes. The user might then select the route/s they are prepared to take and also designate their preferred route
They could trace their preferred route on a map interface on a device.
Their personal mobile device could record the route as they were driven along it, or their personal mobile sensor to transmit location data to the Hub, which would then publish the data to an application that calculated the route.
The route they travelled as part of a previous transaction could be retrieved from the Information Store.

In the second step, an application may store the information in the user's account (on database #9). It may also store it in the Information Store, independent of the user's account (e.g. if the route is going to be used just once, and immediately).

In the third step, if the route/time/preference is stored in an account, then it may not be the only alternative stored there. As such, the potential service consumer may select which of the stored routes/times/preferences they wish to to enact in this instance, or a priority list. For instance, a user might have a library of stored routes in their account, and the application might ask them to select one of them. To do this, the application might present a list of routes/times from the library to an application on one of the user's devices, and the user might select one or a number of items from the list, or prioritize them. Depending on the way this choice process is constructed, the application may pass the information through the Information Store and the Bus, or it may by-pass them completely.

A preferred route or preference is now within the Information Store, or a timetable is now within an external database, ready to be called when demanded by a potential service consumer (see module 9).

FIG. 9 shows data being transferred from the sensors on the devices of a user (#5) (i.e. a personal mobile device (#6), and an external device (#7)) to their account in an external database (#9) directly and via the Bus (Some applications might transfer the data directly, while others might go through the Bus.) Data that enter the Bus may also be transferred to the Information Store. Finally, the figure shows some routes/times/preferences (or index information about those routes/times/preferences) being transferred from an external account to the Information Store, and from the Information Store to the user (via the Hub) so that the user might select between them. (Direct transfers between the databases and the Information Store or the sensors and the Information Store (i e not via the Bus) are plausible, but not likely in this situation. An application that draws on the capabilities of the Information Store is also likely to draw on the capabilities of the Bus. Therefore, direct transfers are not shown in the figure.) Interactions with external databases to download maps etc. are excluded.

Module 9. Matching Transaction Partners

Given two potential transaction partners, many applications require that they be matched. This may take the form of matching a user to a vehicle that has a published route, but variable time (e.g. scenarios 1, 7). Alternatively, it may take the form of two parties, both of which have unpublished routes and times (e.g. scenarios 2, 3, and 4). The match could be achieved multiple ways. The following represents one possibility for a car-pooling application. A parallel process, in which riders solicit rides, would have a very similar structure
As noted above (see modules 7 and 8), all requests and offers for rides are in the Information Store along with their route/time/preference information.
For every driver in the system, the Bus retrieves the acceptable timing and route for that driver from the Information Store.
The Bus retrieves all outstanding requests for rides that are acceptable to that driver.
The application ranks the ride requests in terms of total deviation (in time and/or distance) from the driver's preferred route.
The application goes down the preferred list and verifies the estimated deviations. In particular, it checks that the driver can actually get to the rider (rather than, say, driving close by on a freeway). It could also estimate the expected time that the deviation would take, given the expected traffic in the time envelope.
The application publishes the ranked list to the appropriate device or the driver. In addition it might send other information that might help the driver to make a decision, such as:
   The number of matches that rider has in the database.
   Information such as the number of outstanding offers to that rider, the times at which they were made, and an indication of how this potential ride ranks compared to other offers the rider has.
   Potential riders' time window, origin, and destination. This might be displayed on a map, so that the driver can see whether riders can be combined, or in case there are barriers to picking up riders of which the application has not been informed (such as construction works).
   Information about the quality of the other party such as:
      Ratings by other users
      System-generated measures (e.g. punctuality history)
The driver selects a rider, and a similar offer is made to that rider along with other relevant information, such as:
   Information about the driver and vehicle (user ratings, system-generated ratings, demerit points etc.)
   The other offers the driver has made (including origin and destination information)
      Those that have not been accepted
      Those that are provisionally accepted (see immediately below)
      Those that are confirmed
If the rider accepts the ride, it is flagged as “provisionally accepted” and other riders who will be in the vehicle at the same time as this rider are offered a veto (possibly by email or SMS). If they decline to veto, then the rider is confirmed. At this point, the rider is removed from the list of potential riders and all outstanding offers relating to this ride are rejected.
Once the rider is confirmed, the drivers list of potential riders and associated deviations is updated to reflect the new route.
   When the driver flags that the ride is closed, the ride disappears from the lists of potential rides.

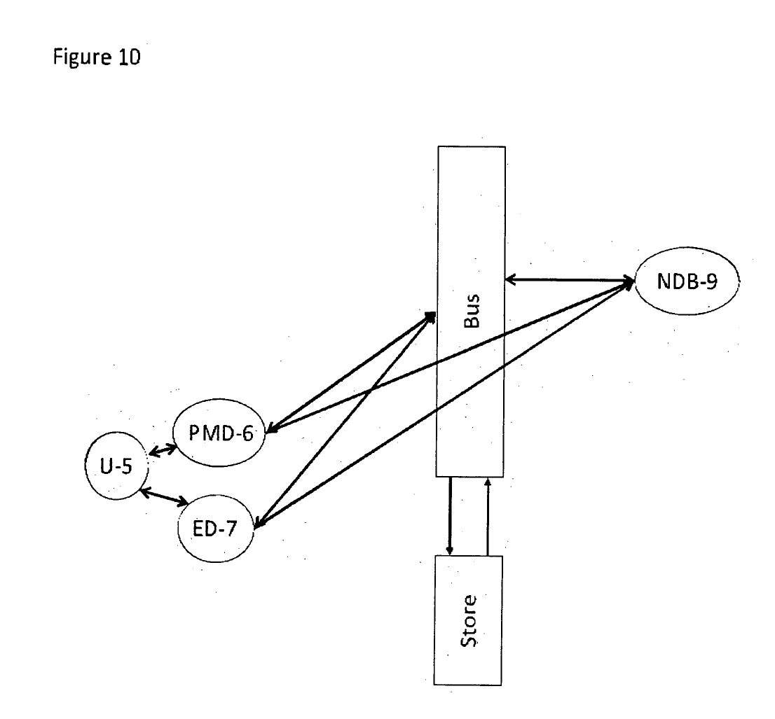

FIG. 10 shows the various personal sensors interacting with the Hub, and the Hub interacting with the Information Store and an external database to achieve this. Interactions with external databases to download maps etc. are excluded.

The process for matching a rider to an open-access vehicle (e.g. taxi, train, machine in scenario 9) on the basis of real-time location information would be similar, but much simpler, since the ride giver would not have discretion in the transaction. Such a procedure might also incorporate a model predicting when the vehicle would arrive at a particular location.

The process for matching a rider to a public transport vehicle on the basis of schedule information would be similar and simpler still.

Module 10. Bringing Transaction Partners Together Physically

If two transaction partners wish to share a journey, such as two car-poolers getting together (scenario 4), a taxi finding a passenger (scenario 3), or a truck picking up a piece of freight (scenario 2) then the two parties need to be brought together in time and in space.

Again, using car-pooling as an example, there are two situations to consider:
1. A driver might pick up a rider at a designated pick-up point
2. The ride begins jointly from a particular location designated by the driver (such as a workplace parking lot)

There are many ways of achieving a pick-up at a designated point. However, an application might assist the connection using tools such as the following
The application generates a route to the designated location on the basis of available maps (in an external database (#8))
The Hub publishes messages to applications on the devices of the parties These messages allow them to see each other on a map) once they are within a certain distance or after a certain time (e.g. ten minutes before the scheduled pick-up time).
The Hub publishes a warning (e.g. a text message) once the one party is within a specified time or distance of the other.
The Hub enables a VOIP or chat communication application between the parties, possibly at a designated time or distance separation.
The application generates estimated times of arrival for the parties on the basis of their current location, current traffic patterns, and historical performance of drivers in general, or this driver in particular, along that route. Some of this information is drawn from external databases, some of it is drawn from the Information Store, and some of it is constructed from an analysis of data in the Information Store. It sends those estimates to applications on devices controlled by the driver and the rider

To commence the trip together at a particular location (e.g. a university, car park, a workplace, or an airport car park) the Hub must learn the location. This may be achieved a number of ways
One of the parties can send the location to the Hub by entering the coordinates of the location manually, or by nominating a point on a map in an application.
The application can use the Hub to extract the last recorded location of the vehicle sensor from the Information Store.
The driver can designate the end location of the last transaction as the starting location of the next.
An application instructs the Hub to record the location at which a personal mobile sensor is removed from a cradle in a vehicle.
One of the parties can send the location to the Hub by initiating an application on the same device as their personal mobile sensor or vehicle-mounted sensor, when positioned at the designated location.
One of the parties can supplement information generated by the application (e g by annotating the location information to say that the vehicle is on the fifth floor of the parking garage)

Once the location is known, the parties need to get to the right place at the right time. In order to get them there at the right time, the application may:
Estimate the time it takes to walk from the current location of the user's personal mobile sensor to the designated location, and publish that to an application on the user's device.
Publish a reminder message to the user a designated period before the scheduled time, using an absolute value, a value based on the estimated walk time, a value based on the distance, or some other means.

In order to get them to the right place, the application may:
Provide the users with a map showing the route, and instruct the Hub to publish their current location on that map.
Instruct the Hub to send a notification when the personal mobile sensor of the user comes within a specified distance of the personal mobile sensor of the other user or the vehicle sensor.

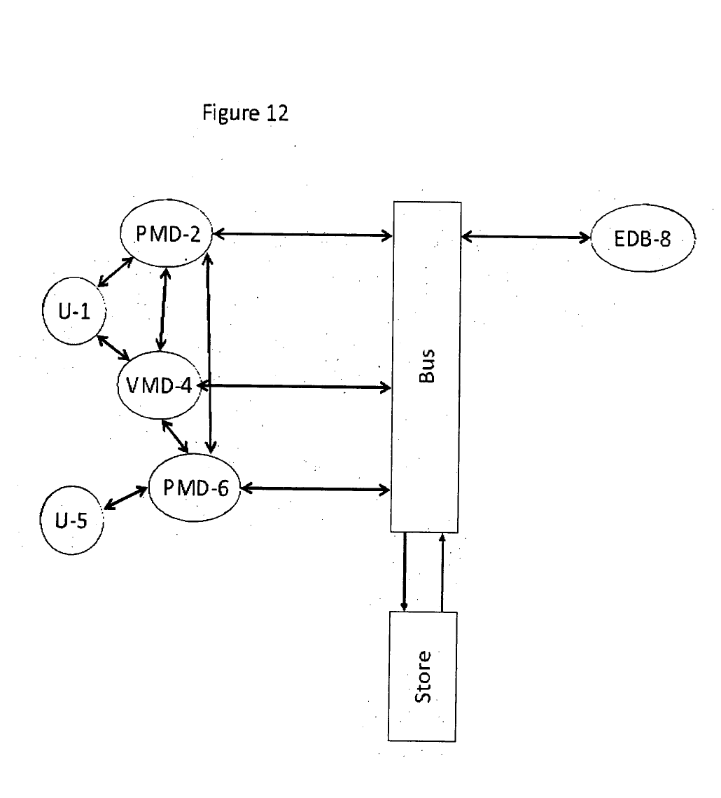

FIG. 12 shows the processes involved in bringing two parties together in physical space so they can enter into a transaction. The Bus goes to the Information Store or an external database to download information such as maps, routes and information about current traffic and previous locations of the sensors The various sensors communicate with the Bus to tell the application their location, send supplementary information, and receive messages.

Module 11. Ensuring the Safety of Transaction Partners

This module has particular applicability to car-pools and taxis, though it may well find use in other situations. The essential function it performs is to keep a given party safe from threat from the other party.

Safety can be achieved in a number of ways
Assisted selection:
   Putting in filters that prevent high risk individuals participating in the transaction (see under registration), and putting in place mechanisms to help potential transaction partners assess the risk associated with a given potential partner (e.g. participants rate each other at the end of the transaction). An application might have the capacity to update this information every time it is needed. For instance, it could go to the drivers' licence database and check that the driver's licence is still valid every time a driver offered a ride or that he or she has not had a driving or any other conviction.
   Empowering external parties (such as parents or guardians) to oversee the selection process.
Positive identification: It the registrant believes that the registration process is rigorous, and there is a process at the start of a transaction to authenticate that the exchange partners are the registrants, then this should discourage a participant doing anything untoward They know the registrar can identify them easily The rigour of the registration process is discussed under the registration module. There are a number of ways in which participants might authenticate that their transaction partner is the registrant for the transaction. All of these involve downloading identification data to the registrant, generally to their vehicle-mounted device or their personal mobile device. Data that may be downloaded include:
   A photograph
   A signature
   A voice recording
   A spectral analysis of their voice recording that could be compared to a spectrum generated when they first meet
   An iris scan
   A finger print
Monitoring the journey: Using the Hub, it is possible to monitor that the journey is proceeding as planned Possible means of monitoring the journey include
   If they parties have agreed on a specific route for the journey, an individual or an application can monitor whether the personal mobile sensors of the participants or the vehicle-mounted mobile sensor deviate from the agreed route by more than a prescribed distance.
   Once the journey has begun, and before the agreed destination is reached, an individual or an application can monitor whether the two personal mobile devices become physically separated (e.g. by seeing whether a Bluetooth pairing is broken or an application may note the sensors are at different physical locations).
   Once, the journey has begun, and before the agreed destination is reached, an individual or an application can monitor whether either of the personal mobile sensors becomes physically separated from the vehicle-mounted sensor.
   An individual or an application can monitor whether the vehicle takes longer than the expected time to reach the destination. The expected duration could take into account the current traffic conditions and the historical driving behaviour of the driver.
   An external party (such as a parent or guardian) might monitor the journey in real time on a screen.
Panic: Each participant might have access to a “hot button’ on their personal mobile device that could be used to alert the police or other authorities directly.
Intervention: If a monitoring failure occurs, then there are a number of interventions that the registrar or another authority might make to assure the safety of the parties. The intervener might escalate the intervention, employing some of the following steps, possibly in order:
   Send a message to both (e.g. an SMS message), and require them to enter their PIN to cancel the alarm
   If one of the personal mobile sensors has ceased transmitting, it may be due to a flat battery. Therefore, send a message to one party through the vehicle-mounted mobile sensor or personal mobile sensor of the other, and ask them to submit a PIN.
   Call the parties on their personal mobile devices and compare the voices to voices samples on file
   Call a friend of the parties and instruct them to call them on their personal mobile devices
   Remotely activate a camera (and possibly microphone) within the vehicle-mounted device and observe (and possibly listen to) the cockpit of the vehicle
   Instruct the police to attend the location/s of the sensors
   Send a signal, through the vehicle-mounted device, to shut down the vehicle.

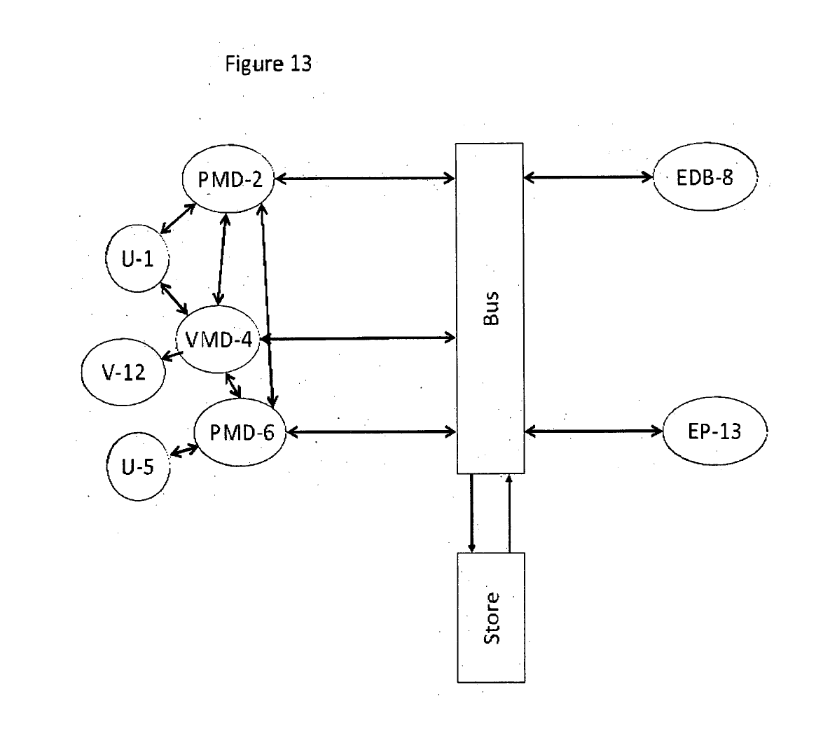

FIG. 13 shows the vehicle-mounted device and the two personal mobile devices interacting with each other, and with the Hub, and the Hub drawing information from the Information Store and an external database. It also shows the vehicle (V) (#12) being controlled via the vehicle-mounted device, and on external party (EP) (#13) intervening during a crisis.

Module 12. Dynamic Optimization

Scenarios 2, 11, and 12 call for the capacity to dynamically optimize the routes and tasks of a number of vehicles. A freight forwarder with multiple trucks in a city, a military planner organising food, fuel, and equipment in a war game, or a coordinator of a response to a natural disaster may wish to move tasks between resources (e.g. vehicles, people and equipment) and resources to different locations, as contingencies play out and information comes to hand The techniques for carrying out such an optimisation are well established within the present art (dynamic programming, linear programming, etc.). In addition, as discussed in the notes for scenario 11, it may be desirable to provide participants in a complex dynamic system with the capacity to visualize their situation so they can improvise strategies manually.

In order to perform the former, an application would simply extract the relevant data from the Information Store, perform the optimization calculations, and present the results to the user The key capability the Hub provides is the ability to do this repeatedly as the situation changes.

In order to perform the latter, an application, or the individuals themselves, would subscribe applications on the devices of relevant individuals to receive data outputs from the Hub (such as a mapping program).

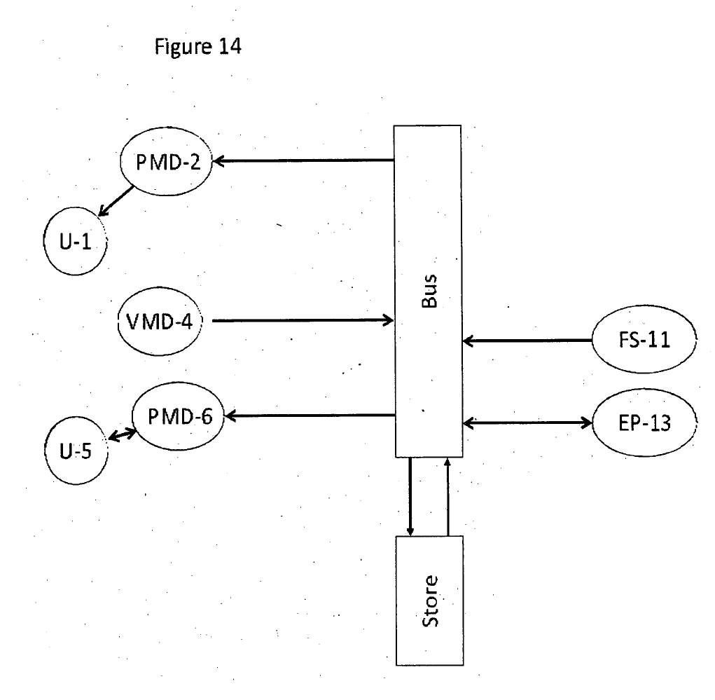

FIG. 14 illustrates these processes. Various sensors on vehicles (#4) (attached to user #1) and fixed sensors (#11) are providing data to the Hub An external party (#13) runs the optimization routines using data in the Information Store. Appropriate results are sent back to people in the field (#1) (via PMD-2), people managing the situation (#13) and the general public (#6).

1. A system for handling public transport information in a transportation domain comprising hardware to receive, transmit, store and aggregate real-time information, hardware to enable one or more users to interact with the information in real time and hardware to share information based on one or more criteria, the criteria comprising registration to use the system, wherein the information is aggregated from one or more sensors.

2. A system for handling transport information comprising hardware to receive information, hardware to transmit information and optionally hardware to store information.

3. A system according to claim 1 comprising hardware to share information based on one or more criteria, the criteria optionally comprising registration to use the system.

4. A system according to claim 1 wherein the information comprises real-time information which is optionally aggregated and optionally from one or more sensors.

5. A system according to claim 1 comprising hardware to enable one or more users to interact with the information and optionally in real time.

6. A system according to claim 1 adapted for use with a transportation domain and optionally in relation to one or more of: public transport, emergency services, commercial transport, freight, passenger transport and the like.

7. A method for handling transport information comprising the steps of receiving information, transmitting information and optionally storing information.

8. A method according to claim 7 the step of sharing information based on one or more criteria, the criteria optionally comprising registration to use the system.

9. A method according to claim 7 wherein the information comprises real-time information which is optionally aggregated and optionally from one or more sensors.

10. A method according to claim 7 one or more users may interact with the information and optionally in real time.

11. A method according to claim 7 adapted for use with a transportation domain and optionally in relation to one or more of: public transport, emergency services, commercial transport, freight, passenger transport and the like.

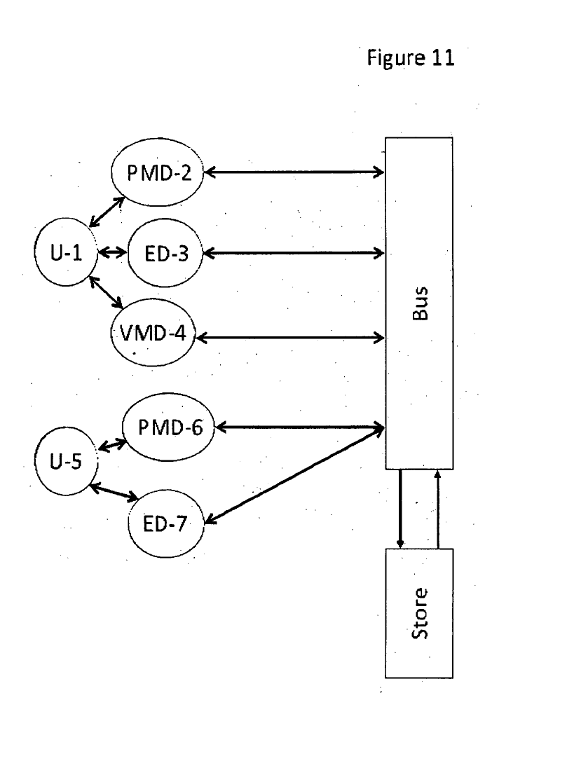

12. A system or method as herein described in one or more of the Scenarios, Modules or by reference to one or more of FIGS. 2 to 14 herein.

13. A method as herein described for optionally one or more of:
a. Choosing between transportation modes
b. Opening and closing a transaction
c. Observing the state of a variable at a remote location
d. Service provider registers an intended route or schedule or preference
e. Services consumer registers an intended route or schedule or preference
f. Matching transaction partners
g. Bringing transaction partners together physically
h. Ensuring the safety of transaction partners
i. Reliably aggregating data in complex evolving systems so that system optimizations might be carried out frequently.

14. A method for enabling car pooling comprising one or more of the following:
a. pooling users are registered in a database;
b. pooling users are checked against a registry of compliance information prior to entering into a transaction;
c. pooling users have the capacity to authenticate the other party as the person who is registered in the database;
d. allowing some pool users to have the capacity to restrict, select, or veto the riding partners of other riders (e.g. parents);
e. allowing some pool users have the capacity to monitor the rides of other users in real time (e.g. parents);
f. journeys are monitored by an external authority
g. procedures are in place for managing a safety threat.

15. A transport information method comprising one or more of:
a. providing users the capacity to examine the value of a state variable, or the forecast of that state variable, related to a remote location's ability to satisfy their needs;
b. planning journeys based on the value of a state variable;
c. providing people the capacity to plan journeys using real-time data;
d. providing agents with the capacity to manage complex logistics systems using real-time data, where those logistics systems are centrally coordinated (e.g. freight or military logistics), or where they involve local improvisation (e.g. disaster response);
e. registering providers and recipients of transportation services such that every time the person initiates a transaction, the system re-validates their eligibility and updates their status within the system (eg. checks they still have a valid licence and no demerit points);
f. enabling participants in a transaction to authenticate the other party through the use of photos of the person, photos of the vehicle, signatures, vehicle registration numbers, finger prints, iris scans, voice spectra, voice recordings etc;
g. calculating expected trip durations using a method that incorporates real-time traffic conditions, and/or a model of expected traffic conditions based on historical data, and/or historical behaviour of that driver;
h. taxis having the capability to only take a ride in a pre-specified area or direction;
i. booking trucks for their return journeys;
j. assuring safety for passengers undertaking trips (i.e. authentication+filters+monitoring+panic+intervention);
k. monitoring car-pools and other transportation services—i.e. the system triggers on deviation from a nominated route;
l. monitoring car-pools and other transportation services—i.e. the system triggers on the basis of sensors being proximate then separated;
m. assuring someone's safety whereby they input a PIN into someone else's personal sensor;
n. assuring someone's safety whereby a private vehicle is fitted with a camera/audio device and that camera/audio device transmits images and/or sound to an external party in response to a command by that external party;
o. recording the location of a stationary vehicle by various methods, including a sensor attached to it, the location at which a previous transaction was closed, or by someone pushing a button on a sensor;
p. using data about the location of a stationary vehicle to guide a party to that vehicle;
q. enabling VOIP or Chat communication between two parties when they come within a specified time or distance from each other;
r. automatically opening a transaction when two sensors are registered as being co-located, or a sensor reaches a specified location;
s. automatically closing a transaction when two paired sensors separate;
t. automatically closing a transaction for transportation services when a pre-specified location is reached;
u. facilitating frequent updating of data inputs for optimization routines for managing complex dynamic scheduling problems.

16. A storage device comprising machine readable instructions to carry out any one or more of the methods or steps described herein and/or in claim 7.
